(19) United States
(12) Patent Application Publication
(10) Pub. No.: US 2024/0292232 A1
(43) Pub. Date: Aug. 29, 2024

(54) METHOD FOR PERFORMING BEAM MANAGEMENT IN WIRELESS COMMUNICATION SYSTEM AND DEVICE THEREFOR

(71) Applicant: LG Electronics Inc., Seoul (KR)

(72) Inventors: Eunjong LEE, Seoul (KR); Kyungho LEE, Seoul (KR); Sangrim LEE, Seoul (KR)

(21) Appl. No.: 18/570,514

(22) PCT Filed: Jun. 18, 2021
(86) PCT No.: PCT/KR2021/007690

§ 371 Date: Dec. 14, 2023

(51) Int. Cl. H04W 16/28; H04L 5/00; H04W 24/10; H04W 74/0838; H04W 76/19; H04W 80/02

(52) U.S. Cl. CPC H04W 16/28; H04L 5/0051; H04W 24/10; H04W 74/0838; H04W 76/19; H04W 80/02

(57) ABSTRACT

A method of performing a beam management in a wireless communication system and a device therefor are disclosed. The method performed by a user equipment (UE) comprises receiving, from a base station (BS), configuration information including i) resource information on a plurality of reference signals and ii) candidate beam determination algorithm information, determining N candidate beams for at least one serving beam based on the candidate beam determination algorithm information, the N candidate beams being related to N reference signals of the plurality of reference signals, receiving, from the BS, the N reference signals of the plurality of reference signals based on the resource information on the plurality of reference signals, and transmitting, to the BS, measurement information including at least one measurement value among the N reference signals.

### TECHNICAL FIELD

The present disclosure relates to a wireless communication system, and more particularly to a method of performing a beam management based on machine learning and a device supporting the same.

### BACKGROUND ART

Wireless communication systems have been widely deployed to provide various types of communication services such as voice or data, and attempts to integrate artificial intelligence (AI) into communication systems are rapidly increasing.

AI integration methods that are being attempted may be roughly divided into C4AI (communications for AI) which develops communication technology to support AI, and AI4C (AI for communications) which uses AI to improve communication performance.

In the AI4C area, there are attempts to increase design efficiency by replacing a channel encoder/decoder with an end-to-end autoencoder.

In the C4AI area, there is a method of updating a common prediction model while protecting personal information by sharing only weight or gradient of a model with a server without sharing raw data between devices based on federated learning which is a technique of distributed learning. Further, there are methods to distribute the load on devices, network edges, and cloud servers based on split inference.

### DISCLOSURE

### Technical Problem

The present disclosure provides a method of performing a beam management by measuring only optimal candidate beams without separate signaling using machine learning, and a device therefor.

The technical objects to be achieved by the present disclosure are not limited to those that have been described hereinabove merely by way of example, and other technical objects that are not mentioned can be clearly understood by those skilled in the art, to which the present disclosure pertains, from the following descriptions.

### Technical Solution

The present disclosure provides a method of performing a beam management in a wireless communication system. The method performed by a user equipment (UE) may comprise receiving, from a base station (BS), configuration information including i) resource information on a plurality of reference signals and ii) candidate beam determination algorithm information, determining N candidate beams for at least one serving beam based on the candidate beam determination algorithm information, the N candidate beams being related to N reference signals of the plurality of reference signals, receiving, from the BS, the N reference signals of the plurality of reference signals based on the resource information on the plurality of reference signals, and transmitting, to the BS, measurement information including at least one measurement value among the N reference signals.

Based on the at least one serving beam being changed, new N candidate beams may be determined based on the candidate beam determination algorithm information.

Based on there being no reference signal whose a measurement value exceeds a threshold among the measured N reference signals, a number of candidate beams for measurement may be increased by +1.

The configuration information may further include at least one of information on N contention free random access (CFRA) resources and/or information on a number of candidate beams.

The method may further comprise, based on a pre-configured method, mapping the N CFRA resources to the N reference signals, determining one beam related to one reference signal of the N reference signals based on the resource information on the plurality of reference signals, and performing a beam failure recovery operation based on a CFRA resource related to the one beam.

The method may further comprise, based on a beam failure of the at least one serving beam being detected, measuring the N reference signals based on the resource information on the plurality of reference signals, and transmitting, to the BS, beam failure recovery (BFR) medium access control (MAC)-control element (CE) information. The BFR MAC-CE information may include a bitmap representing a reference signal, whose a measurement value exceeds a threshold among the N reference signals, for at least one serving cell.

A user equipment (UE) configured to perform a beam management in a wireless communication system according to the present disclosure may comprise at least one transceiver, at least one processor operatively connected to the at least one transceiver, and at least one memory operatively connected to the at least one processor and configured to store instruction that allow the at least one processor to perform operations, wherein the operations may comprise receiving, from a base station (BS), configuration information including i) resource information on a plurality of reference signals and ii) candidate beam determination algorithm information, determining N candidate beams for at least one serving beam based on the candidate beam determination algorithm information, the N candidate beams being related to N reference signals of the plurality of reference signals, receiving, from the BS, the N reference signals of the plurality of reference signals based on the resource information on the plurality of reference signals, and transmitting, to the BS, measurement information including at least one measurement value among the N reference signals.

The present disclosure provides a method of performing a beam management in a wireless communication system. The method performed by a base station (BS) may comprise transmitting, to a user equipment (UE), configuration information including i) resource information on a plurality of reference signals and ii) candidate beam determination algorithm information, determining N candidate beams for at least one serving beam based on the candidate beam determination algorithm information, the N candidate beams being related to N reference signals of the plurality of reference signals, transmitting, to the UE, the N reference signals of the plurality of reference signals based on the resource information on the plurality of reference signals, and receiving, from the UE, measurement information including at least one measurement value among the N reference signals.

Based on the at least one serving beam being changed, new N candidate beams may be determined based on the candidate beam determination algorithm information.

Based on there being no reference signal whose a measurement value exceeds a threshold among the measured N reference signals, a number of candidate beams for measurement may be increased by +1.

The configuration information may further include at least one of information on N contention free random access (CFRA) resources and/or information on a number of candidate beams.

The method may further comprise, based on a pre-configured method, mapping the N CFRA resources to the N reference signals, and performing a beam failure recovery operation based on a CFRA resource related to one reference signal of the N reference signals.

Based on a beam failure of the at least one serving beam being detected, the N reference signals may be measured based on the resource information on the plurality of reference signals. The method may further comprise receiving, from the UE, beam failure recovery (BFR) medium access control (MAC)-control element (CE) information, and the BFR MAC-CE information may include a bitmap representing a reference signal, whose a measurement value exceeds a threshold among the N reference signals, for at least one serving cell.

A base station (BS) configured to perform a beam management in a wireless communication system according to the present disclosure may comprise at least one transceiver, at least one processor operatively connected to the at least one transceiver, and at least one memory operatively connected to the at least one processor and configured to store instruction that allow the at least one processor to perform operations.

The operations may comprise transmitting, to a user equipment (UE), configuration information including i) resource information on a plurality of reference signals and ii) candidate beam determination algorithm information, determining N candidate beams for at least one serving beam based on the candidate beam determination algorithm information, the N candidate beams being related to N reference signals of the plurality of reference signals, transmitting, to the UE, the N reference signals of the plurality of reference signals based on the resource information on the plurality of reference signals, and receiving, from the UE, measurement information including at least one measurement value among the N reference signals.

A processor device configured to control a user equipment (UE) to perform a beam management in a wireless communication system according to the present disclosure may comprise at least one processor, and at least one memory operatively connected to the at least one processor and configured to store instruction that allow the at least one processor to perform operations, wherein the operations may comprise receiving, from a base station (BS), configuration information including i) resource information on a plurality of reference signals and ii) candidate beam determination algorithm information, determining N candidate beams for at least one serving beam based on the candidate beam determination algorithm information, the N candidate beams being related to N reference signals of the plurality of reference signals, receiving, from the BS, the N reference signals of the plurality of reference signals based on the resource information on the plurality of reference signals, and transmitting, to the BS, measurement information including at least one measurement value among the N reference signals.

In a non-transitory computer readable medium (CRM) according to the present disclosure storing instruction that allow at least one processor to perform operations, the operations may comprise receiving, from a base station (BS), configuration information including i) resource information on a plurality of reference signals and ii) candidate beam determination algorithm information, determining N candidate beams for at least one serving beam based on the candidate beam determination algorithm information, the N candidate beams being related to N reference signals of the plurality of reference signals, receiving, from the BS, the N reference signals of the plurality of reference signals based on the resource information on the plurality of reference signals, and transmitting, to the BS, measurement information including at least one measurement value among the N reference signals.

### ADVANTAGEOUS EFFECTS

The present disclosure has an effect of performing a beam management by measuring only optimal candidate beams without separate signaling using machine learning.

The present disclosure also has an effect of reducing a beam tracking latency due to reconfiguration by measuring a beam with larger coverage without radio resource control reconfiguration.

FIG. 11(a) illustrates an example of configuring a UE-specific CSI-RS.

FIG. 11(b) illustrates an example of configuring a UE group-specific CSI-RS.

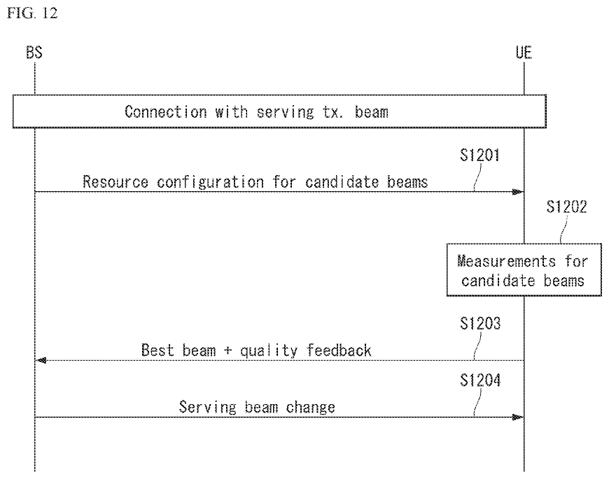

FIG. 12 illustrates an example of a conventional beam management procedure.

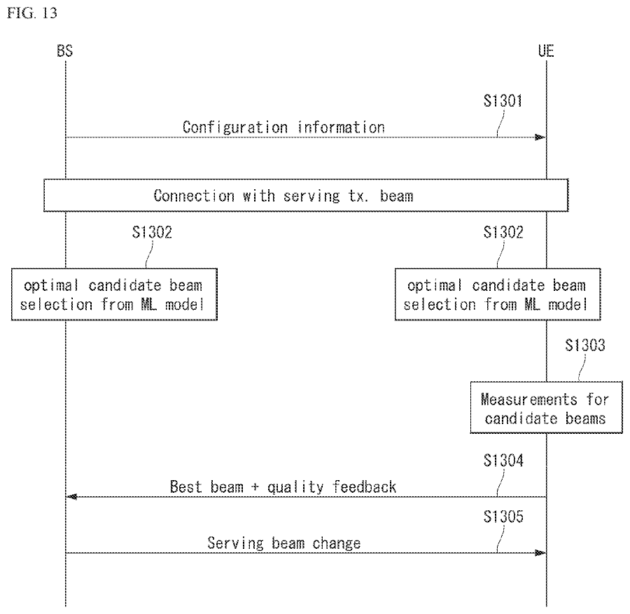

FIG. 13 illustrates an example of a beam management method described in the present disclosure.

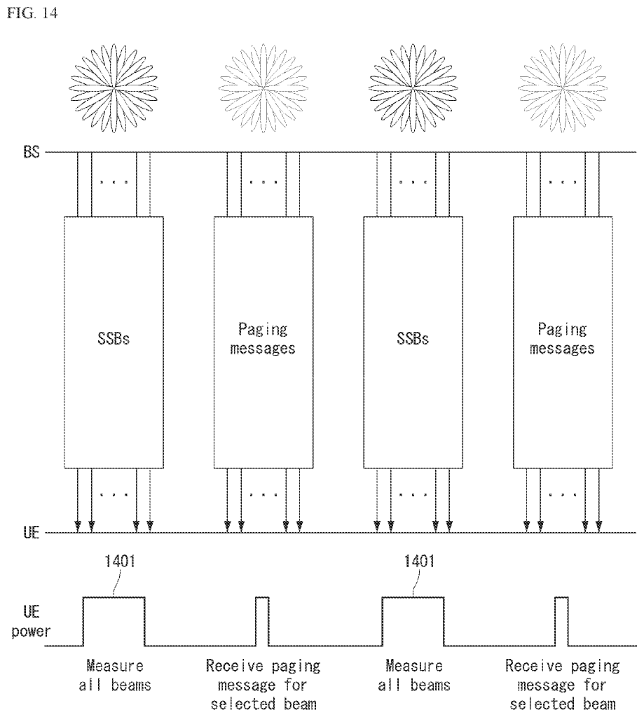

FIG. 14 illustrates an example of SSB reception and measurement of an idle mode UE according to a prior art.

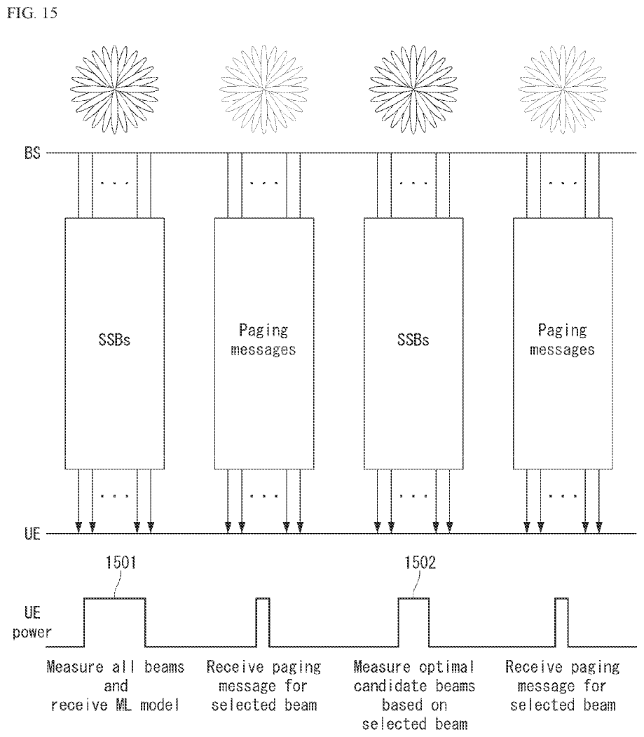

FIG. 15 illustrates an example of SSB reception and measurement of an idle mode UE described in the present disclosure.

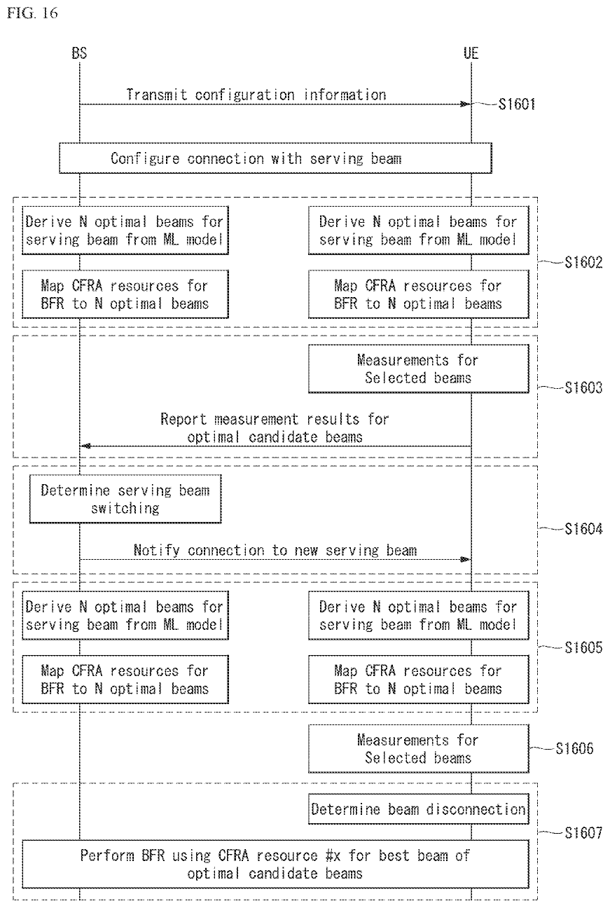

FIG. 16 illustrates an example of a BFR procedure described in the present disclosure.

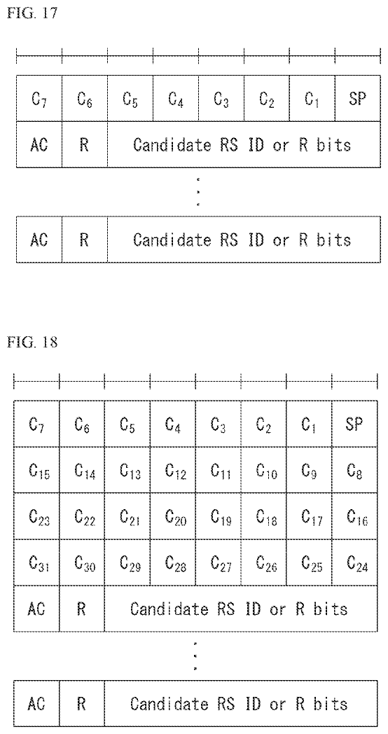

FIG. 17 illustrates BFR and Truncated BFR MAC CE in which the highest ServCellIndex of MAC entity's SCell configured with beam failure detection (BFD) is less than 8.

FIG. 18 illustrates BFR and Truncated BFR MAC CE in which the highest ServCellIndex of MAC entity's SCell configured with BFD is equal to or greater than 8.

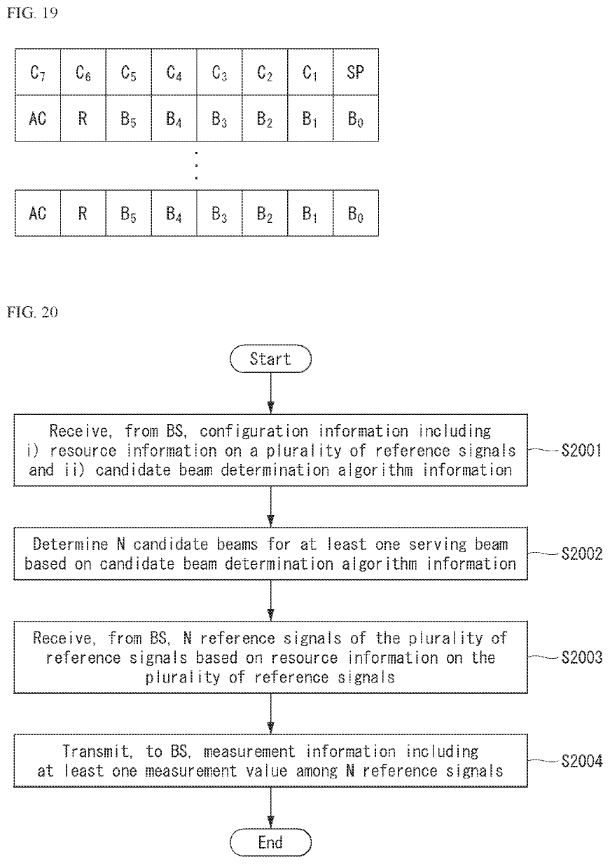

FIG. 19 illustrates an example of BFR MAC CE described in the present disclosure.

FIG. 20 is a flow chart illustrating an operation method of a UE described in the present disclosure.

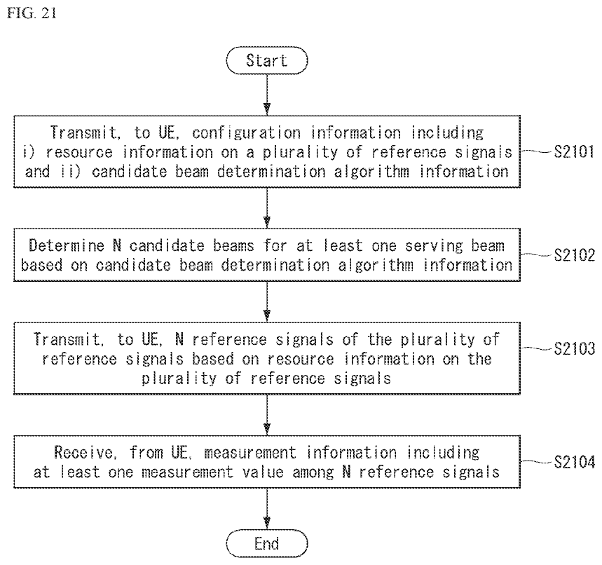

FIG. 21 is a flow chart illustrating an operation method of a base station described in the present disclosure.

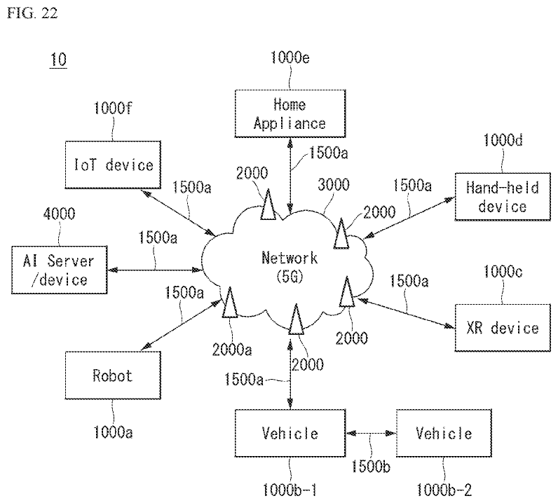

FIG. 22 illustrates a communication system 10 applied to the present disclosure.

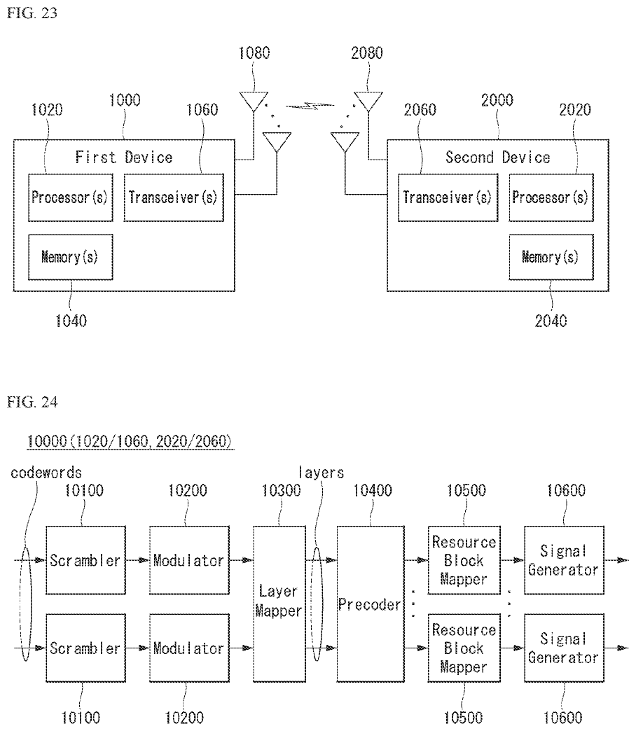

FIG. 23 illustrates a wireless device applicable to the present disclosure.

FIG. 24 illustrates a signal processing circuit for a transmission signal.

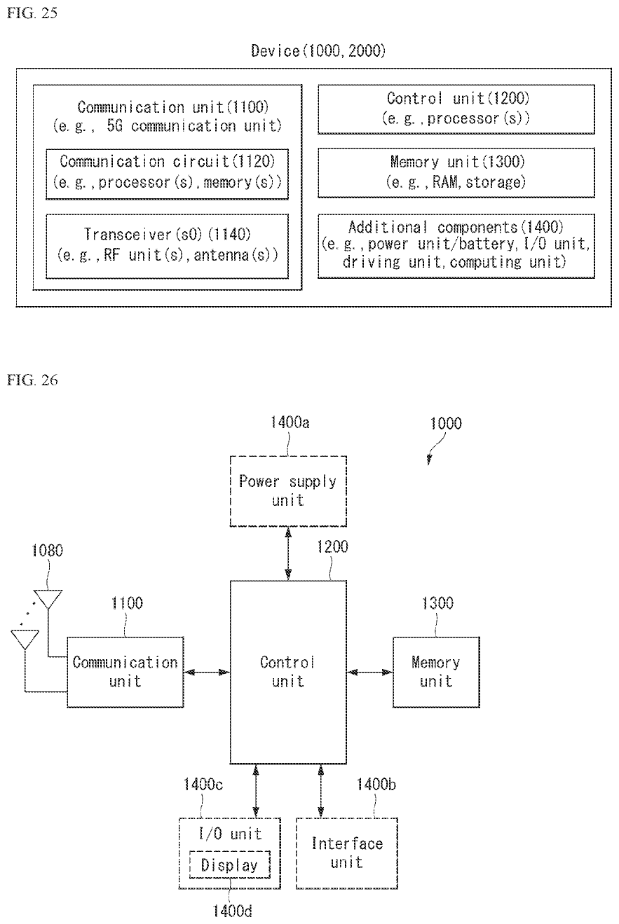

FIG. 25 illustrates another example of a wireless device applied to the present disclosure.

FIG. 26 illustrates a hand-held device applied to the present disclosure.

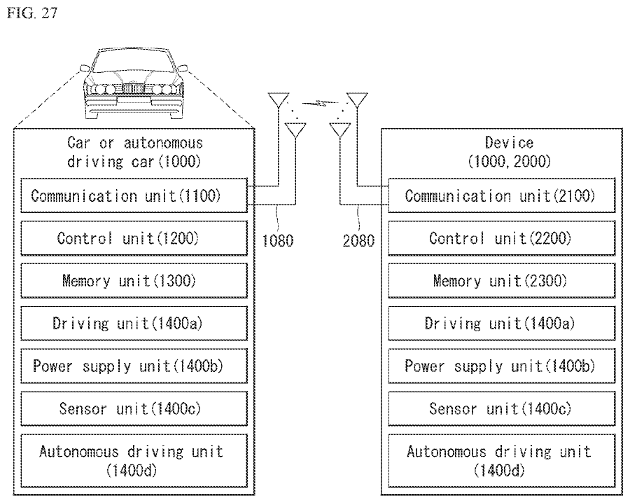

FIG. 27 illustrates a vehicle or an autonomous vehicle applied to the present disclosure.

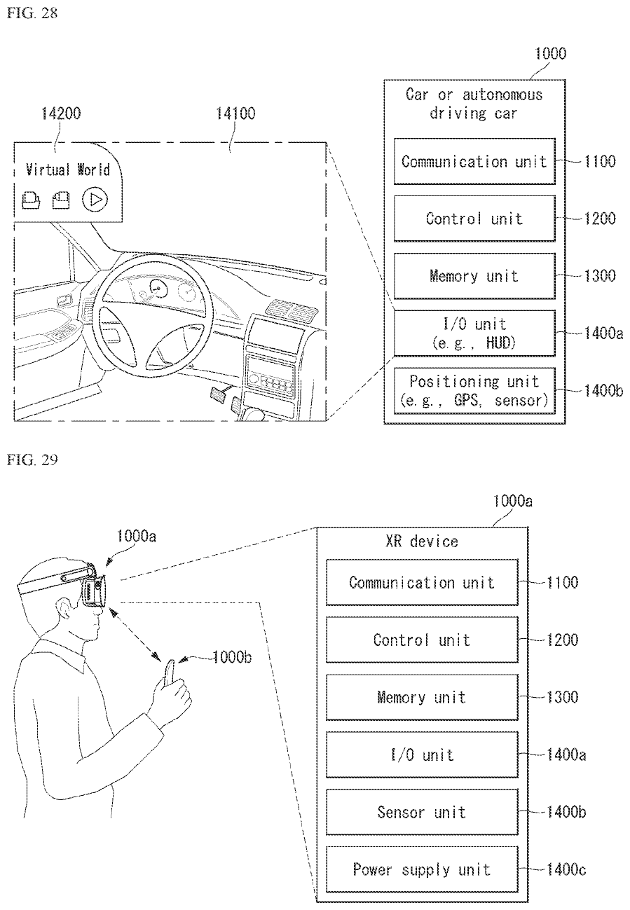

FIG. 28 illustrates a vehicle applied to the present disclosure.

FIG. 29 illustrates an XR device applied to the present disclosure.

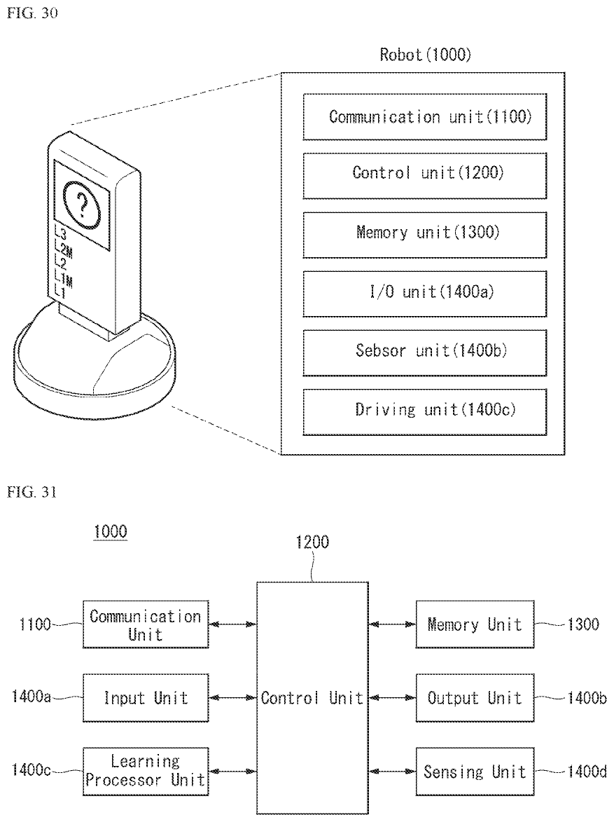

FIG. 30 illustrates a robot applied to the present disclosure.

FIG. 31 illustrates an AI device applied to the present disclosure.

### MODE FOR INVENTION

Reference will now be made in detail to embodiments of the present disclosure, examples of which are illustrated in the accompanying drawings. A detailed description to be disclosed below together with the accompanying drawing is to describe exemplary embodiments of the present disclosure and not to describe a unique embodiment for carrying out the present disclosure. The detailed description below includes details to provide a complete understanding of the present disclosure. However, those skilled in the art know that the present disclosure may be carried out without the details.

In some cases, in order to prevent a concept of the present disclosure from being ambiguous, known structures and devices may be omitted or illustrated in a block diagram format based on core functions of each structure and device.

In the present disclosure, a base station means a terminal node of a network directly performing communication with a terminal. In the present disclosure, specific operations described to be performed by the base station may be performed by an upper node of the base station in some cases. That is, it is apparent that in a network constituted by multiple network nodes including the base station, various operations performed for communication with the terminal may be performed by the base station or other network nodes other than the base station. The ‘base station (BS)’ may be substituted with terms such as a fixed station, Node B, evolved-NodeB (eNB), a base transceiver system (BTS), an access point (AP), gNB (general NB, generation NB), and the like. Further, the ‘terminal’ may be fixed or movable and be substituted with terms such as a user equipment (UE), a mobile station (MS), a user terminal (UT), a mobile subscriber station (MSS), a subscriber station (SS), an advanced mobile station (AMS), a wireless terminal (WT), a Machine-Type Communication (MTC) device, a Machine-to-Machine (M2M) device, a Device-to-Device (D2D) device, and the like.

Hereinafter, downlink (DL) means communication from the base station to the terminal and uplink (UL) means communication from the terminal to the base station. In downlink, a transmitter may be part of the base station, and a receiver may be part of the terminal. In uplink, the transmitter may be part of the terminal and the receiver may be part of the base station.

Specific terms used in the following description are provided to help the understanding of the present disclosure and the use of the specific terms may be modified into other forms within the scope without departing from the technical spirit of the present disclosure.

The following technology may be used in various radio access system including CDMA, FDMA, TDMA, OFDMA, SC-FDMA, and the like. The CDMA may be implemented as radio technology such as Universal Terrestrial Radio Access (UTRA) or CDMA2000. The TDMA may be implemented as radio technology such as a global system for mobile communications (GSM)/general packet radio service (GPRS)/enhanced data rates for GSM evolution (EDGE). The OFDMA may be implemented as radio technology such as Institute of Electrical and Electronics Engineers (IEEE) 802.11 (Wi-Fi), IEEE 802.16 (WiMAX), IEEE 802.20, Evolved UTRA (E-UTRA), or the like. The UTRA is a part of Universal Mobile Telecommunications System (UMTS). 3rd Generation Partnership Project (3GPP) Long Term Evolution (LTE) is a part of Evolved UMTS (E-UMTS) using the E-UTRA and LTE-Advanced (A)/LTE-A pro is an evolved version of the 3GPP LTE. 3GPP NR (New Radio or New Radio Access Technology) is an evolved version of the 3GPP LTE/LTE-A/LTE-A pro. 3GPP 6G may be an evolved version of 3GPP NR.

Embodiments of the present disclosure may be supported by standard documents disclosed in at least one of IEEE 802, 3GPP, and 3GPP2 that are wireless access systems. Thai is, steps or portions of the embodiments of the present disclosure which are not described in order to clearly illustrate the technical spirit of the present disclosure may be supported by the standard documents. Further, all terms disclosed in the present disclosure may be described by the standard documents.

For clarity in the description, the following description will mostly focus on 3GPP communication system (e.g. LTE-A or 5G NR). However, technical features according to an embodiment of the present disclosure will not be limited only to this. LTE means technology after 3GPP TS 36.xxx Release 8. In detail, LTE technology after 3GPP TS 36.xxx Release 10 is referred to as the LTE-A and LTE technology after 3GPP TS 36.xxx Release 13 is referred to as the LTE-A pro. The 3GPP NR means technology after TS 38.xxx Release 15. The LTE/NR may be referred to as a 3GPP system. “xxx” means a detailed standard document number. The LTE/NR/6G may be collectively referred to as the 3GPP system. For terms and techniques not specifically described among terms and techniques used in the present disclosure, reference may be made to a wireless communication standard document published before the present disclosure is filed. For example, the following document may be referred to.

### 3GPP LTE

36.211: Physical channels and modulation
36.212: Multiplexing and channel coding
36.213: Physical layer procedures
36.300: Overall description
36.331: Radio Resource Control (RRC)

### 3GPP NR

38.211: Physical channels and modulation
38.212: Multiplexing and channel coding
38.213: Physical layer procedures for control
38.214: Physical layer procedures for data
38.300: NR and NG-RAN Overall Description
38.331: Radio Resource Control (RRC) protocol specification

### Physical Channel and Frame Structure

### Physical Channel and General Signal Transmission

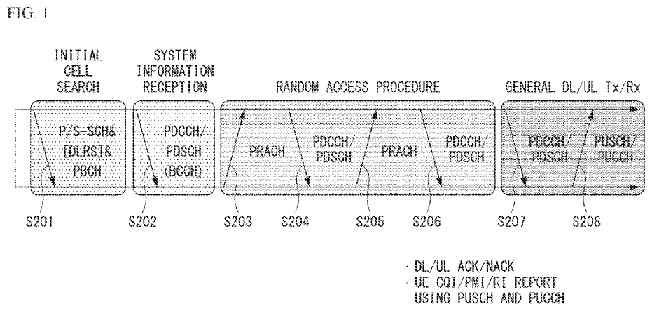

FIG. 1 illustrates physical channels and general signal transmission used in a 3GPP system. In a wireless communication system, the UE receives information from the eNB through Downlink (DL) and the UE transmits information from the eNB through Uplink (UL). The information which the eNB and the UE transmit and receive includes data and various control information and there are various physical channels according to a type/use of the information which the eNB and the UE transmit and receive.

When the UE is powered on or newly enters a cell, the UE performs an initial cell search operation such as synchronizing with the eNB (S701). To this end, the UE may receive a Primary Synchronization Signal (PSS) and a (Secondary Synchronization Signal (SSS) from the eNB and synchronize with the eNB and acquire information such as a cell ID or the like. Thereafter, the UE may receive a Physical Broadcast Channel (PBCH) from the eNB and acquire in-cell broadcast information. Meanwhile, the UE receives a Downlink Reference Signal (DL RS) in an initial cell search step to check a downlink channel status.

A UE that completes the initial cell search receives a Physical Downlink Control Channel (PDCCH) and a Physical Downlink Control Channel (PDSCH) according to information loaded on the PDCCH to acquire more specific system information (S12).

Meanwhile, when there is no radio resource first accessing the eNB or for signal transmission, the UE may perform a Random Access Procedure (RACH) to the eNB (S13 to S16). To this end, the UE may transmit a specific sequence to a preamble through a Physical Random Access Channel (PRACH) (S13 and S15) and receive a response message (Random Access Response (RAR) message) for the preamble through the PDCCH and a corresponding PDSCH. In the case of a contention based RACH, a Contention Resolution Procedure may be additionally performed (S16).

The UE that performs the above procedure may then perform PDCCH/PDSCH reception (S17) and Physical Uplink Shared Channel (PUSCH)/Physical Uplink Control Channel (PUCCH) transmission (S18) as a general uplink/downlink signal transmission procedure. In particular, the UE may receive Downlink Control Information (DCI) through the PDCCH. Here, the DCI may include control information such as resource allocation information for the UE and formats may be differently applied according to a use purpose.

Meanwhile, the control information which the UE transmits to the eNB through the uplink or the UE receives from the eNB may include a downlink/uplink ACK/NACK signal, a Channel Quality Indicator (CQI), a Precoding Matrix Index (PMI), a Rank Indicator (RI), and the like. The UE may transmit the control information such as the CQI/PMI/RI, etc., via the PUSCH and/or PUCCH.

### Structure of Uplink and Downlink Channels

### Downlink Channel Structure

A base station transmits a related signal to a UE via a downlink channel to be described later, and the UE receives the related signal from the base station via the downlink channel to be described later.

(1) Physical Downlink Shared Channel (PDSCH)

A PDSCH carries downlink data (e.g., DL-shared channel transport block, DL-SCH TB) and is applied with a modulation method such as quadrature phase shift keying (QPSK), 16 quadrature amplitude modulation (QAM), 64 QAM, and 256 QAM. A codeword is generated by encoding TB. The PDSCH may carry multiple codewords. Scrambling and modulation mapping are performed for each codeword, and modulation symbols generated from each codeword are mapped to one or more layers (layer mapping). Each layer is mapped to a resource together with a demodulation reference signal (DMRS) to generate an OFDM symbol signal, and is transmitted through a corresponding antenna port.

(2) Physical Downlink Control Channel (PDCCH)

A PDCCH carries downlink control information (DCI) and is applied with a QPSK modulation method, etc. One PDCCH consists of 1, 2, 4, 8, or 16 control channel elements (CCEs) based on an aggregation level (AL). One CCE consists of 6 resource element groups (REGs). One REG is defined by one OFDM symbol and one (P)RB.

The UE performs decoding (aka, blind decoding) on a set of PDCCH candidates to acquire DCI transmitted via the PDCCH. The set of PDCCH candidates decoded by the UE is defined as a PDCCH search space set. The search space set may be a common search space or a UE-specific search space. The UE may acquire DCI by monitoring PDCCH candidates in one or more search space sets configured by MIB or higher layer signaling.

### Uplink Channel Structure

A UE transmits a related signal to a base station via an uplink channel to be described later, and the base station receives the related signal from the UE via the uplink channel to be described later.

(1) Physical Uplink Shared Channel (PUSCH)

A PUSCH carries uplink data (e.g., UL-shared channel transport block, UL-SCH TB) and/or uplink control information (UCI) and is transmitted based on a CP-OFDM (Cyclic Prefix-Orthogonal Frequency Division Multiplexing) waveform, DFT-s-OFDM (Discrete Fourier Transform-spread-Orthogonal Frequency Division Multiplexing) waveform, or the like. When the PUSCH is transmitted based on the DFT-s-OFDM waveform, the UE transmits the PUSCH by applying a transform precoding. For example, if the transform precoding is not possible (e.g., transform precoding is disabled), the UE may transmit the PUSCH based on the CP-OFDM waveform, and if the transform precoding is possible (e.g., transform precoding is enabled), the UE may transmit the PUSCH based on the CP-OFDM waveform or the DFT-s-OFDM waveform. The PUSCH transmission may be dynamically scheduled by an UL grant within DCI, or may be semi-statically scheduled based on high layer (e.g., RRC) signaling (and/or layer 1 (L1) signaling (e.g., PDCCH)) (configured grant). The PUSCH transmission may be performed based on a codebook or a non-codebook.

(2) Physical Uplink Control Channel (PUCCH)

A PUCCH carries uplink control information, HARQ-ACK, and/or scheduling request (SR), and may be divided into multiple PUCCHs based on a PUCCH transmission length.

### 6G System General

A 6G (wireless communication) system has purposes such as (i) a very high data rate per device, (ii) a very large number of connected devices. (iii) global connectivity, (iv) a very low latency, (v) a reduction in energy consumption of battery-free IoT devices, (vi) ultra-reliable connectivity, and (vii) connected intelligence with machine learning capability. The vision of the 6G system may include four aspects such as intelligent connectivity, deep connectivity, holographic connectivity, and ubiquitous connectivity, and the 6G system may satisfy the requirements shown in Table 1 below. That is, Table 1 shows an example of the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

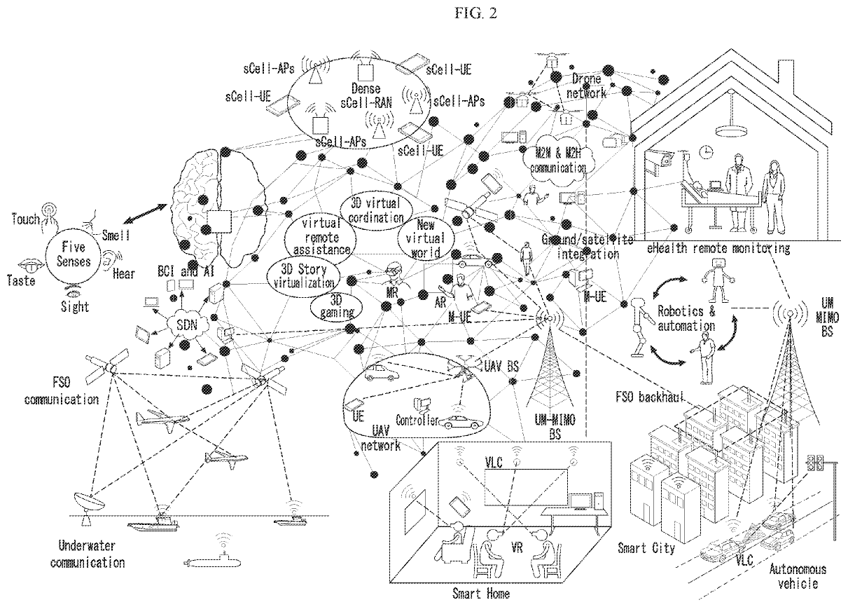

The 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion, and enhanced data security. FIG. 2 illustrates an example of a communication structure providable in a 6G system.

The 6G system is expected to have 50 times greater simultaneous wireless communication connectivity than a 5G wireless communication system. URLLC, which is the key feature of 5G, will become more important technology by providing an end-to-end latency less than 1 ms in 6G communication. The 6G system may have much better volumetric spectrum efficiency unlike frequently used domain spectrum efficiency. The 6G system can provide advanced battery technology for energy harvesting and very long battery life, and thus mobile devices may not need to be separately charged in the 6G system. In 6G, new network characteristics may be as follows.
Satellites integrated network: To provide a global mobile group, 6G will be integrated with satellite. Integration of terrestrial, satellite and public networks into one wireless communication system is critical for 6G.
Connected intelligence: Unlike the wireless communication systems of previous generations, 6G is innovative and may update wireless evolution from “connected things” to “connected intelligence”. AI may be applied in each step (or each signal processing procedure to be described later) of a communication procedure.
Seamless integration of wireless information and energy transfer: A 6G wireless network may transfer power to charge batteries of devices such as smartphones and sensors. Therefore, wireless information and energy transfer (WIET) will be integrated.
Ubiquitous super 3D connectivity: Access to networks and core network functions of drone and very low earth orbit satellite will establish super 3D connectivity in 6G ubiquitous.

In the new network characteristics of 6G described above, several general requirements may be as follows.
Small cell networks: The idea of a small cell network has been introduced to improve received signal quality as a result of throughput, energy efficiency, and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network consisting of heterogeneous networks improves overall QoS and reduces costs.
High-capacity backhaul: Backhaul connectivity is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability. Further, billions of devices can be shared on a shared physical infrastructure.

### Core Implementation Technology of 6G System

### Artificial Intelligence (AI)

Technology which is most important in the 6G system and will be newly introduced is AI. AI was not involved in the 4G system. The 5G system will support partial or very limited AI. However, the 6G system will support AI for full automation. Advance in machine learning will create a more intelligent network for real-time communication in 6G. When AI is introduced to communication, real-time data transmission can be simplified and improved. AI may determine a method of performing complicated target tasks using countless analysis. That is, AI can increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, and in particular, deep learning has been focused on the wireless resource management and allocation field. However, such studies have been gradually developed to the MAC layer and the physical layer, and in particular, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel estimation and channel tracking and may be used for power allocation, interference cancellation, etc. in the physical layer of DL. The machine learning may also be used for antenna selection, power control, symbol detection, etc. in the MIMO system.

However, application of a deep neutral network (DNN) for transmission in the physical layer may have the following problems.

A deep learning based AI algorithm requires a lot of training data in order to optimize training parameters. However, due to limitations in acquiring data in a specific channel environment as the training data, a lot of training data is used offline. Static training for the training data in the specific channel environment may cause a contradiction between the diversity and dynamic characteristics of a radio channel.

Currently, the deep learning mainly targets real signals. However, signals of the physical layer of wireless communication are complex signals. For matching of the characteristics of a wireless communication signal, studies on a neural network for detecting a complex domain signal are further required.

Hereinafter, machine learning is described in more detail.

Machine learning refers to a series of operations to train a machine in order to create a machine capable of doing tasks that people cannot do or are difficult for people to do. Machine learning requires data and learning models. In the machine learning, a data learning method may be roughly divided into three methods, that is, supervised learning, unsupervised learning and reinforcement learning.

Neural network learning is to minimize an output error. The neural network learning refers to a process of repeatedly inputting training data to a neural network, calculating an error of an output and a target of the neural network for the training data, backpropagating the error of the neural network from an output layer to an input layer of the neural network for the purpose of reducing the error, and updating a weight of each node of the neural network.

The supervised learning may use training data labeled with a correct answer, and the unsupervised learning may use training data which is not labeled with a correct answer. That is, for example, in supervised learning for data classification, training data may be data in which each training data is labeled with a category. The labeled training data may be input to the neural network, and the error may be calculated by comparing the output (category) of the neural network with the label of the training data. The calculated error is backpropagated in the neural network in the reverse direction (i.e., from the output layer to the input layer), and a connection weight of respective nodes of each layer of the neural network may be updated based on the backpropagation. Change in the updated connection weight of each node may be determined depending on a learning rate. The calculation of the neural network for input data and the backpropagation of the error may construct a learning cycle (epoch). The learning rate may be differently applied based on the number of repetitions of the learning cycle of the neural network. For example, in the early stage of learning of the neural network, efficiency can be increased by allowing the neural network to rapidly ensure a certain level of performance using a high learning rate, and in the late of learning, accuracy can be increased using a low learning rate.

The learning method may vary depending on the feature of data. For example, in order for a reception end to accurately predict data transmitted from a transmission end on a communication system, it is preferable that learning is performed using the supervised learning rather than the unsupervised learning or the reinforcement learning.

The learning model corresponds to the human brain and may be regarded as the most basic linear model. However, a paradigm of machine learning using, as the learning model, a neural network structure with high complexity, such as artificial neural networks, is referred to as deep learning.

Neural network cores used as the learning method may roughly include a deep neural network (DNN) method, a convolutional deep neural network (CNN) method, and a recurrent Boltzmann machine (RNN) method.

The artificial neural network is an example of connecting several perceptrons.

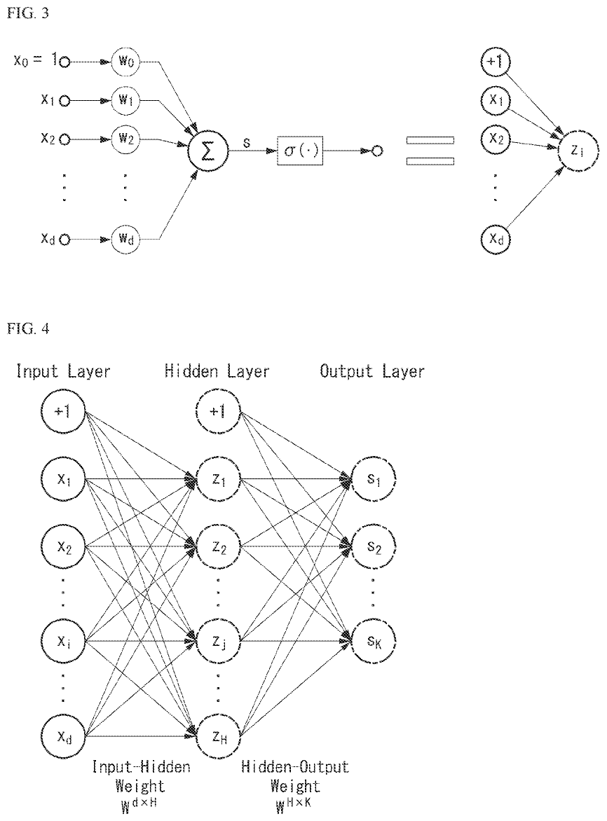

FIG. 3 illustrates an example of a structure of a perceptron.

Referring to FIG. 3, when an input vector x=(x1, x2, . . . , xd) is input, each component is multiplied by a weight (W1, W2, . . . , Wd), and all the results are summed. After that, the entire process of applying an activation function σ(•) is called a perceptron. The huge artificial neural network structure may extend the simplified perceptron structure illustrated in FIG. 3 to apply the input vector to different multidimensional perceptrons. For convenience of explanation, an input value or an output value is referred to as a node.

The perceptron structure illustrated in FIG. 3 may be described as consisting of a total of three layers based on the input value and the output value. FIG. 4 illustrates an artificial neural network in which the number of (d+1) dimensional perceptrons between a first layer and a second layer is H. and the number of (H+1) dimensional perceptrons between the second layer and a third layer is K, by way of example. FIG. 4 illustrates an example of a structure of a multilayer perceptron.

A layer where the input vector is located is called an input layer, a layer where a final output value is located is called an output layer, and all layers located between the input layer and the output layer are called a hidden layer. FIG. 4 illustrates three layers, by way of example. However, since the number of layers of the artificial neural network is counted excluding the input layer, it can be seen as a total of two layers. The artificial neural network is constructed by connecting the perceptrons of a basic block in two dimensions.

The above-described input layer, hidden layer, and output layer can be jointly applied in various artificial neural network structures, such as CNN and RNN to be described later, as well as the multilayer perceptron. The greater the number of hidden layers, the deeper the artificial neural network is, and a machine learning paradigm that uses the sufficiently deep artificial neural network as a learning model is called deep learning. In addition, the artificial neural network used for deep learning is called a deep neural network (DNN).

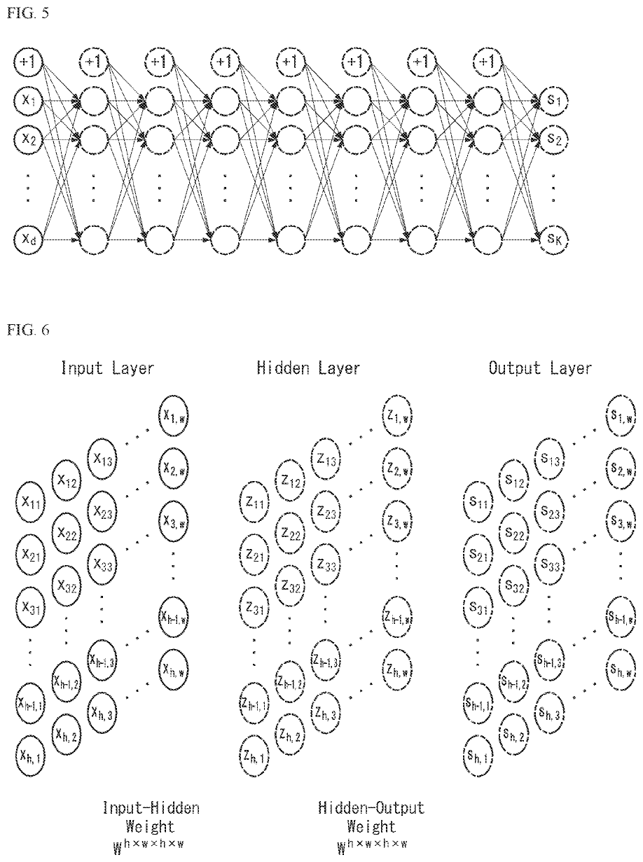

The deep neural network illustrated in FIG. 5 is a multilayer perceptron consisting of eight hidden layers+eight output layers. The multilayer perceptron structure is expressed as a fully connected neural network. In the fully connected neural network, a connection relationship does not exist between nodes located at the same layer, and a connection relationship exists only between nodes located at adjacent layers. The DNN has a fully connected neural network structure and is composed of a combination of multiple hidden layers and activation functions, so it can be usefully applied to understand correlation characteristics between input and output. The correlation characteristic may mean a joint probability of input and output.

Based on how the plurality of perceptrons are connected to each other, various artificial neural network structures different from the above-described DNN can be formed.

In the DNN, nodes located inside one layer are arranged in a one-dimensional longitudinal direction. However, in FIG. 6, it may be assumed that w nodes horizontally and h nodes vertically are arranged in two dimensions (convolutional neural network structure of FIG. 6). In this case, since in a connection process leading from one input node to the hidden layer, a weight is given for each connection, a total of h×w weights needs to be considered. Since there are h×w nodes in the input layer, a total of h2w2 weights are required between two adjacent layers.

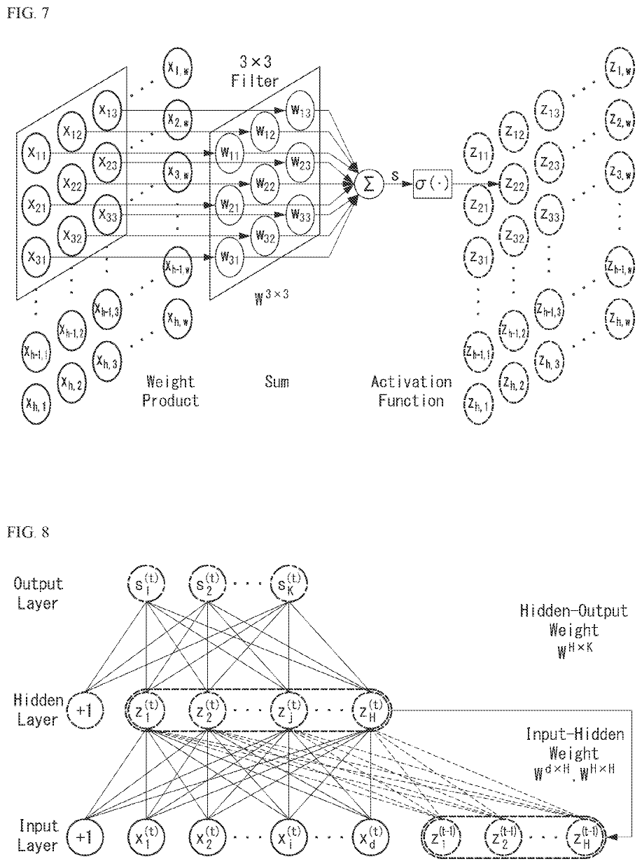

The convolutional neural network of FIG. 6 has a problem in that the number of weights increases exponentially depending on the number of connections. Therefore, instead of considering the connections of all the nodes between adjacent layers, it is assumed that a small-sized filter exists, and a weighted sum and an activation function calculation are performed on an overlap portion of the filters as illustrated in FIG. 7.

One filter has a weight corresponding to the number as much as its size, and learning of the weight may be performed so that a certain feature on an image can be extracted and output as a factor. In FIG. 7, a filter having a size of 3×3 is applied to the upper leftmost 3-3 area of the input layer, and an output value obtained by performing a weighted sum and an activation function calculation for a corresponding node is stored in z22.

The filter performs the weighted sum and the activation function calculation while moving horizontally and vertically by a predetermined interval when scanning the input layer, and places the output value at a location of a current filter. This calculation method is similar to the convolution operation on images in the field of computer vision. Thus, a deep neural network with this structure is referred to as a convolutional neural network (CNN), and a hidden layer generated as a result of the convolution operation is referred to as a convolutional layer. In addition, a neural network in which a plurality of convolutional layers exists is referred to as a deep convolutional neural network (DCNN).

At the node where a current filter is located at the convolutional layer, the number of weights may be reduced by calculating a weighted sum including only nodes located in an area covered by the filter. Hence, one filter can be used to focus on features for a local area. Accordingly, the CNN can be effectively applied to image data processing in which a physical distance on the 2D area is an important criterion. In the CNN, a plurality of filters may be applied immediately before the convolution layer, and a plurality of output results may be generated through a convolution operation of each filter.

There may be data whose sequence characteristics are important depending on data attributes. A structure, in which a method of inputting one element on the data sequence at each time step considering a length variability and a relationship of the sequence data and inputting an output vector (hidden vector) of a hidden layer output at a specific time step together with a next element on the data sequence is applied to the artificial neural network, is referred to as a recurrent neural network structure.

FIG. 8 illustrates an example of a neural network structure in which a circular loop exists.

Referring to FIG. 8, a recurrent neural network (RNN) is a structure in which in a process of inputting elements (x1(t), x2(t), . . . , xd(t)) of any line of sight ‘t’ on a data sequence to a fully connected neural network, hidden vectors (z1(t−1), z2(t−1), . . . , zH(t−1)) are input together at an immediately previous time step (t−1) to apply a weighted sum and an activation function. A reason for transferring the hidden vectors at a next time step is that information within the input vector in previous time steps is considered to be accumulated on the hidden vectors of a current time step.

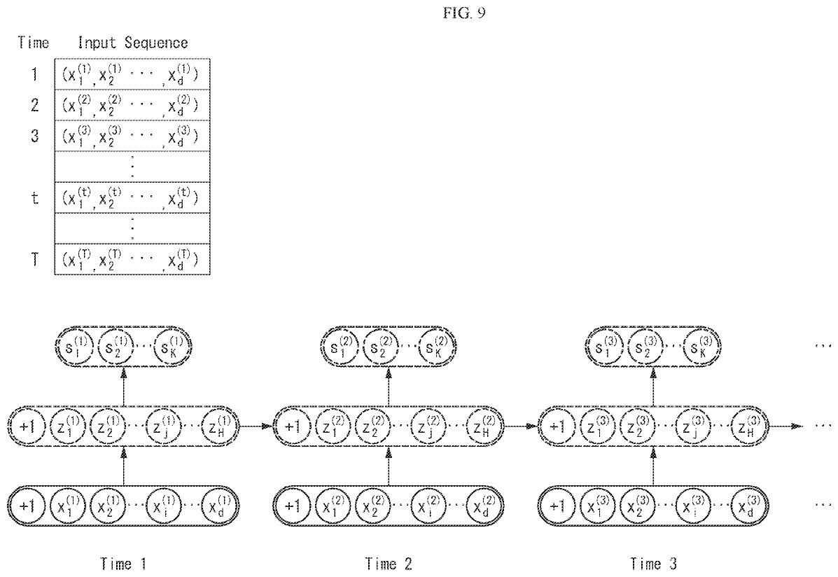

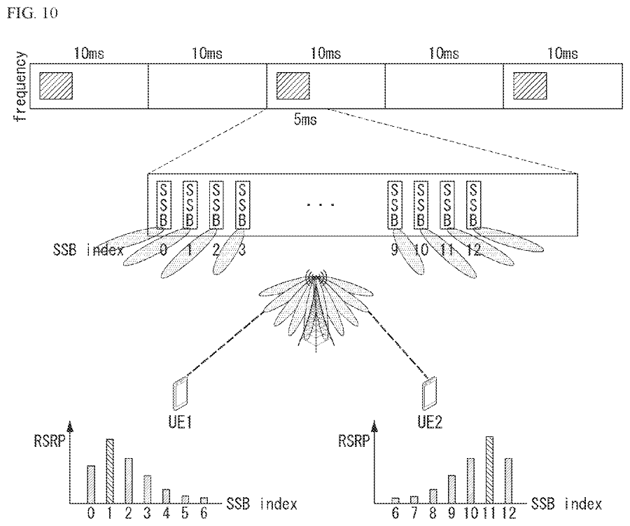

FIG. 9 illustrates an example of an operation structure of a recurrent neural network.

Referring to FIG. 9, the recurrent neural network operates in a predetermined order of time with respect to an input data sequence.

Hidden vectors (z1(1), z2(1), . . . , zH(1)) when input vectors (x1(t), x2(t), . . . , xd(t)) at a time step 1 are input to the recurrent neural network, are input together with input vectors (x1(2), x2(2), . . . , xd(2)) at a time step 2 to determine vectors (z1(2), z2(2), . . . , zH(2)) of a hidden layer through a weighted sum and an activation function. This process is repeatedly performed at time steps 2, 3, . . . , T.

When a plurality of hidden layers are disposed in the recurrent neural network, this is referred to as a deep recurrent neural network (DRNN). The recurrent neural network is designed to be usefully applied to sequence data (e.g., natural language processing).

A neural network core used as a learning method includes various deep learning methods such as a restricted Boltzmann machine (RBM), a deep belief network (DBN), and a deep Q-network, in addition to the DNN, the CNN, and the RNN, and may be applied to fields such as computer vision, speech recognition, natural language processing, and voice/signal processing.

Recently, attempts to integrate AI with a wireless communication system have appeared, but this has been concentrated in the field of wireless resource management and allocation in the application layer, network layer, in particular, deep learning. However, such research is gradually developing into the MAC layer and the physical layer, and in particular, attempts to combine deep learning with wireless transmission in the physical layer have appeared. The AI-based physical layer transmission refers to applying a signal processing and communication mechanism based on an AI driver, rather than a traditional communication framework in the fundamental signal processing and communication mechanism. For example, deep learning-based channel coding and decoding, deep learning-based signal estimation and detection, deep learning-based MIMO mechanism, AI-based resource scheduling and allocation, and the like, may be included.

### Reinforcement Learning

Reinforcement learning (RL) is a type of machine learning and is a learning method that does not require any specific model. In general, the RL is often implemented as Q-leaning, which is a method of updating a Q value through learning and selecting an optimal action depending on the Q value. The Q value may be referred to as a Q-table. Main operations of the RL may be described as an action, a state, and a reward. That is, the learning is done to select the optimal action, and its goal is to obtain the greatest reward by selecting a specific action. The reward is defined when there is a state transition. When the RL is expressed mathematically, it takes the form of Markov process. The Markov process is a process in which a current state is determined by a past state, and may be expressed as a state transition diagram.

An algorithm of the Q-learning is as follows. It consists of one agent, a finite set S of states, and a set Aₛ⊂A of actions that can be taken in each state s∈S. If any action a∈Aₛ is taken in any state s, the agent gets a corresponding reward. The agent's goal is to maximize a sum of rewards. To do this, the agent shall learn what action is optimal to take in each state. The optimal action in each state refers to an action that provides the greatest long-term reward in that state. When the long-term reward is calculated, an expected value of a sum of discounted rewards is usually calculated, and a reward r obtained after time Δt from now is discounted by γ^{Δt} and calculated as rγ^{Δt}. In this case, γ is a discount factor with a value between 0 and 1, and is a value that indicates how much more important a reward currently obtained is than a reward obtained in the future. The algorithm has a Q function for each state-action pair as shown in Equation 1 below.

$$Q : S \times A \to R \qquad [ Equation 1 ]$$

Before the algorithm starts, the Q function has a fixed random value. At each time t, the agent takes an action aₜ in any state sₜ and transitions to a state sₜ₊₁. In this instance, a reward rₜ is obtained, and the Q function is updated. The core of the algorithm is a simple value repetition method that uses a weighted sum of a previous value and new information, as shown in Equation 2 below.

$$Q ( {s}_{t} , {a}_{t} ) ← ( 1 - α ) Q ( {s}_{t} , {a}_{t} ) + α ( {r}_{t} + γ Q ( {s}_{t + 1} , {a}_{t} ) ) \qquad [ Equation 2 ]$$

Here, α is a learning rate factor and has a value between 0 and 1. If the state sₜ₊₁ reached is an end state, an episode ends. However, the Q-learning is possible even if its task consists of an episode. This is because if the discount factor γ is less than 1, the discounted sum is finite even if repeated infinitely. Further, when an action is selected during the Q-learning, it may be selected based on the learned Q value as shown in Equation 3 below or selected in a random manner. This is known as an ε-greedy exploitation-exploration method.

$$a ( t + 1 ) = \{ \begin{matrix}arg {max}_{a} Q ( s ( t + 1 ) , a ) , & with probability 1 - e \\ random , & with probability e\end{matrix} \qquad [ Equation 3 ]$$

### Beam Management Method of 5G System

Beam management in the 5G system may be explained in terms of operations (e.g., in connected UEs) in a network access step (e.g., RACH procedure) and after a cell connection.

Since a UE that first enters a cell does not have a beam connected to a base station, the UE first performs an operation of finding a downlink (DL) beam of the base station. The NR uses a synchronization signal block (SSB) to which a physical broadcast channel (PBCH) is transmitted to help a DL beam search of the UE. That is, SSBs containing the same system information may be mapped to up to 64 different beams within 5 ms and may be transmitted, and are repeatedly transmitted at a constant cycle depending on cell configuration.

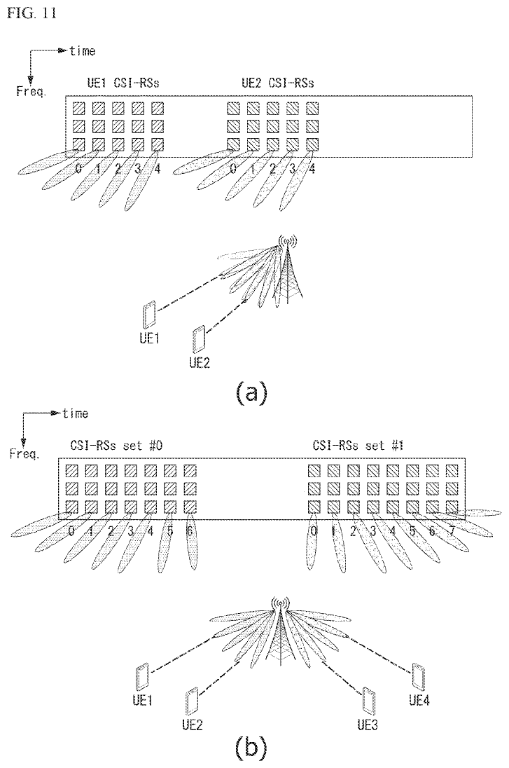

FIG. 10 illustrates an example of a UE operation of selecting a downlink beam in a network access step.

Referring to FIG. 10, a UE may receive SSBs within 5 ms every 20 ms. The SSBs within each 5 ms may include SSBs with indexes 0 to 12. The SSBs within 5 ms may be respectively mapped to different beams and transmitted. A first UE (i.e., UE1) and a second UE (i.e., UE2) may measure a reference signal received power (RSRPs) of SSBs mapped to different beams to select a best beam. For example, the first UE may select a beam mapped to an SSB of index 1 through RSRP measurement as the best beam, and the second UE may select a beam mapped to an SSB of index 11 through RSRP measurement as the best beam. The first UE and the second UE may inform a base station (BS) of information (i.e., best beam) on the DL beam using physical random access channel (PRACH) resources mapped to the selected best beam.

If an initial beam between the base station and the UE is configured through a RACH procedure and a cell connection process of the UE is completed, the base station may configure a CSI measurement and reporting method of the UE for continuous beam/link management of the UE. In the NR, channel state information-reference signal CSI-RS) and/or SSB resources may be used for the beam management of the UE.

In the SSB resource, a beam used for the CSI-RS resource typically has a narrower beam width than a beam used for the SSB in a method of using beam mapping for the SSB used in the RACH procedure. The base station figures out an approximate location and/or beam of the UE using the SSB transmitted over a wider sweeping range in a network access step, and performs a beam refinement process for configuring a narrower beam for the connected UE.

As described above, while the narrower beam can provide the UE with higher performance data transmission and reception services, it may be sensitively affected by a link disconnection phenomenon due to the movement or blockage of the UE as the coverage of the UE becomes smaller.

Further, the NR introducing a beamforming technique manages a link of the UE through beam-based measurement, which significantly increases power consumption of the UE.

Thus, as a method to minimize the power consumption of the UE due to the beam-based measurement and prevent the beam disconnection through continuous beam tracking, the base station informs the UE of candidate beams via radio resource control (RRC) configuration (e.g., CSI-ResourceConfig). This allows the base station to pre-configure CRI-RS resources and/or SSB resources for the candidate beams considering mobility of the UE and allows the UE to measure an intensity of a narrow candidate beam and report a measurement result in advance, thereby enabling switching to a new beam before a serving beam is disconnected.

FIG. 11 illustrates an example of beam refinement of a cell access UE. FIG. 11(a) illustrates an example of configuring a UE-specific CSI-RS, and FIG. 11(b) illustrates an example of configuring a UE group-specific CSI-RS.

Allocating CSI-RS and/or SSB per UE, as illustrated in FIG. 11(a), means that different CSI-RS resources and/or SSB resources can be allocated even to different UEs using beams of the same direction.

Specifically, referring to FIG. 1l(a), CSI-RS #0 to #4 of a first UE (i.e., UE1) are respectively mapped to beams of the same direction as CSI-RS #0 to #4 of a second UE (i.e., UE2), but are allocated to different resources from the CSI-RS #0 to #4 of the second UE (i.e., UE2).

Because the base station can arbitrarily select candidate beams suitable for the UE and map the candidate beams to CSI-RS resources and/or SSB resources, the above method enables free beam management of the base station without RRC reconfiguration according to the movement of the UE within the cell. However, as the number of UEs within the cell increases, an overhead problem of the CSI-RS resources occurs.

As a method to reduce the resulting CSI-RS resource overhead, the base station, as illustrated in FIG. 11(b), may allocate the same CSI-RS resources to different UEs located within a specific coverage and manage the respective UEs to measure an intensity of the same beam. The NR defines a bundle of the CSI-RS resources as a CSI-RS resource set and defines a bundle of the SSB resources as an SSB resource set.

However, the management method causes the UEs with different mobility using the same CSI-RS resource set and/or SSB resource set to undergo frequent RRC reconfiguration.

For example, the overhead problem in the CSI-RS resource can be solved by respectively allocating the same CSI-RS resource set #0 to #1 to first to fourth UEs (i.e., UE1, UE2, UE3, and UE4) illustrated in FIG. 11(b). However, if one UE of the UEs using the same set is beyond the corresponding coverage, the one UE shall be configured with a new CSI-RS resource set. This causes a trade-off problem between the RRC reconfiguration and a measurement burden of the UE.

If the number of CSI-RS resources within the CSI-RS resource set is reduced to reduce the measurement burden of the UE, the frequent RRC reconfiguration problem occurs again. Therefore, to solve the problem, the base station may configure a CSI-RS resource set including up to 64 CSI-RS resources capable of covering a larger coverage.

However, this increases the measurement burden and the power consumption of the UE by allowing the UE to measure a large number of beams (e.g., up to 64 CSI-RS resources are configurable within one CSI-RS resource set).

In particular, in the case of a UE (e.g., high-speed vehicle) moving at a high speed, the frequent RRC configuration may cause latency in beam management, leading to the frequent beam disconnection phenomenon. To alleviate this problem, configuring candidate beams with larger coverage greatly increases the power consumption of the UE as the number of beams to be measured by the UE increases.

As such, the beam management method in the current NR has a problem in that the base station has to manage the CSI-RS resources in an appropriate method by considering trade-offs for system resource efficiency, the measurement burden of the UE, and the frequent RRC reconfiguration.

The present disclosure seeks to solve the trade-off problem for system resource efficiency, the measurement burden of the UE, and the frequent RRC reconfiguration that inevitably occurs in the process of configuring the UE candidate beams in the current technology.

Below, before proposed methods of the present disclosure are described, a beam management procedure in the NR is described in more detail.

FIG. 12 illustrates an example of a conventional beam management procedure.

Referring to FIG. 12, a base station (BS) transmits, to a user equipment (UE). CSI-RS and/or SSB resource configuring information (or resource configuring information) constructing proper candidate beams based on a beam connected to the UE and CSI reporting configuration, in step S1201.

The UE receiving this measures reference signal (RS) signals allocated to the resource configuring information, in step S1202.

The UE selects four beams with a best RSRP among them and reports (or feedbacks) RSRP (or feedback information) for this to the BS, in step S1203.

The BS receiving this may indicate beam switching to a new beam based on the feedback information, in step S1204. The UE may change a serving beam to a new beam based on the indication.

As above, in the current NR technology, the candidate beams are configured by informing resource information of CSI-RS and/or SSB that has to be measured by the UE. That is, the CSI-RS and/or the SSB configured with an RRC message by the BS mean a beam that has to be always transmitted for beam measurement of the UE. In other words, if the BS configures the resource information of the CSI-RS and/or the SSB with the RRC message, the BS shall transmit all the CSI-RS and/or the SSB configured for beam measurement of the UE.

A method of reporting channel state information in an NR system is described in more detail below. In the present disclosure, the ‘NR system’ may be used with the same meaning as the ‘5G system’.

The method of reporting channel state information (or, beam channel state information) in the NR system may be described as a method of reporting channel state information for beam management when there is connectivity with a beam (e.g., CSI reporting) and a method of reporting beam information for beam recovery after connection to a beam is lost (e.g., BFR).

A UE with connectivity to a beam may transmit beam intensity information for surrounding candidate beams based on reporting configuration of the BS. For example, the beam intensity information may be reported in periodic, aperiodic, or semi-persistent. The NR defines it a CSI framework.

CSI of the NR may be used by being divided into uses of CSI estimation, time-frequency tracking, and mobility in addition to the beam management based on configuration of the BS on a CSI-RS resource set and/or an SSB resource set.

The beam management is to ensure connection to a new beam (e.g., beam tracking/tracking) when the quality of a current connection beam (e.g., serving beam) deteriorates as the BS continuously and/or as needed receives information on surrounding candidate beams of the UE through the CSI reporting.

However, because a beam disconnection phenomenon may frequently occur even with small changes in the surrounding environment due to characteristics of beamforming, the NR additionally provides a device that allows the UE itself to transmit information for beam connection to the base station after the beam disconnection.

That is, the UE determines the beam disconnection by itself (e.g., beam failure detection) and informs information on a qualified beam through an RACH procedure using PRACH resource mapping information that has been pre-configured to the candidate beams through the beam intensity measurement of the candidate beams. Alternatively, if beam connection of a specific cell is lost in a carrier aggregation (CA) environment, the UE can recover the beam connection by transmitting a beam failure recovery (BFR) medium access control (MAC) control element (CE) containing the information on the candidate beams via link of other cell. The NR defines it as a beam failure recovery procedure.

As above, because the beam information reporting method in the NR shall measure a large number of candidate beams and transmit the information on the candidate beams, if the CSI reporting is used, the UE transmits only beam intensity information for four beams with the highest intensity among the candidate beams, that are measured based on the CSI reporting configuration of the BS, as values of CRI/SSBR1+L1-RSRP (e.g., CRI and L1-RSRP or SSBR1 and L1-RSRP).

In addition, for the BFR, contention free random access (CFRA) resources for the candidate beams of the UE may be pre-allocated. When the UE declares beam failure detection (BFD) and performs the BFR, even if only a CFRA resource for one beam among the pre-allocated CFRA resources is used, this is a resource that has to be pre-allocated for the UE, and there is a problem in which the unnecessarily large number of CFRA resources are allocated when the number of candidate beams increases. Beam information may be transmitted using a BFR MAC CE for Scell. However, even in this case, because only information on beams exceeding a specific threshold among the candidate beams is transmitted, the UE shall transmit CRI/SSBR1 information.

As above, in the beam information transmitting method in the NR, additional signaling overhead, such as CRI/SSBR1 in CSI and BFR MAC CE, occurs as the number of candidate beams increases, and there is a resource waste problem in that the unnecessarily large number of CFRA resources has to be pre-allocated in the BFR procedure using the CFRA resources.

The present disclosure allows the BS and the UE to measure only optimal candidate beams using mapping information (e.g., model using ML. Q-table through RL, and/or information on a specific table provided by the BS, etc.) for optimal candidate beams for a pre-learned/pre-configured specific serving beam, and report state information on them.

Through this, the present disclosure eliminates the transmission of signaling information for the candidate beam configuration and transmits information of beam measurement result using minimal resources.

The present disclosure proposes a method for UEs newly entering a cell to efficiently manage a beam while solving a trade-off problem, that inevitably occurs in the prior art, using beam information of a base station that has been pre-learned without new learning based on a machine learning algorithm/Q-table learned above.

The present disclosure proposes a procedure or method of performing an efficient beam management between a UE and a base station using an algorithm/machine learning that derives optimal candidate beams for a specific beam.

In particular, according to the present disclosure, the UE may receive, from the base station, information (e.g., algorithm/ML model/ML) on an algorithm/machine learning (ML) model, that derives optimal candidate beams based on a current serving beam among beams within the cell, together with resource information on reference signals (e.g., CSI-RS, SSB) corresponding to the beams within the cell. The UE receiving the information on the reference signals and the information on the algorithm/ML model may derive candidate beams based on the serving beam without additional signaling for candidate beam configuration, measure beam quality through measurement of the reference signals corresponding to the derived candidate beams, and inform the base station of a result of the measurement.

According to the present disclosure, the base station may transmit together, to the UE, the resource information on the reference signals corresponding to the beams within the cell while transmitting, to the UE, the information on the algorithm/ML model deriving the optimal candidate beams for the current serving beam. Even if the base station pre-allocates resources for the reference signals corresponding to the beams within the cell, the base station may transmit only the reference signals for the derived candidate beams for the serving beam of the UE(s). For example, the base station may configure/transmit resource information for all the reference signals and transmit only the reference signals for the derived candidate beams for the serving beam of the UE.

In the present disclosure, ‘/’ means ‘and’, ‘or’, or ‘and/or’ based on context.

Hereinafter, the present disclosure describes information on an algorithm/ML model for deriving optimal candidate beams, and then describes in detail a beam management method and a beam failure recovery method using the information. The present disclosure also describes a method of reporting a BFR MAC CE format and feedback information.

Embodiments described below in the present disclosure are merely distinguished for convenience of explanation. Thus, it is obvious that partial method and/or partial configuration of any embodiment can be substituted or combined with partial method and/or partial configuration of another embodiment.

Information on the algorithm/ML model for deriving the optimal candidate beams is first described in detail.

### Information on Algorithm/ML Model for Deriving Optimal Candidate Beams

Information on an algorithm/ML model for deriving optimal candidate beams used in the present disclosure is a matter of base station implementation, and it may assume that learning for a candidate beam list of respective configurable beams within a cell has been completed or defined before cell deployment by a base station vendor.

For example, the information on the algorithm/ML model for deriving the optimal candidate beams may be a list of candidate beam list information for a specific beam, a trained ML model, and/or information (e.g., Q-table) on a Q-table in the case of reinforcement learning

For example, the list of candidate beam list information for the specific beam may mean information defined within a base station as information to which a list of candidate beams corresponding to each beam for all beams in the cell is mapped. For example, when a total of m beams are in the cell, a list of candidate beams for zeroth to (m−1)-th beams may be determined, and a list of information on them may be transmitted to a UE.

For example, the trained ML model may be a model in which, when a serving beam index is input as an input value, a list of n candidate beams is derived as an output value. For example, the ML model may be a model that has been trained based on supervised learning, unsupervised learning, reinforcement learning, or the like. And/or, when a UE with a connection to a specific beam used as an input value (i.e., a serving beam to which an index is input) measures surrounding beams, beams that are predicted/judged/learned to have the highest intensity may be candidate beams. And/or, when output candidate beams are output by softmax, beams up to an N-th output value may be defined as candidate beams for the serving beam based on N value determined by the base station or by a specific rule.

For example, for the information on the Q-table, the base station may update the Q-table through reinforcement learning using Q-learning to learn the optimal candidate beams. When the reinforcement learning is completed, information on the updated Q-table may be transmitted to the UE. The base station and the UE may input beams within the cell as state information and determine n beams with high rewards for the beams as the candidate beams.

And/or, the base station may also transmit, to the UE, information on the number (N) of candidate beams derived together with the information (e.g., the information on the algorithm/ML model for deriving the optimal candidate beams). In other words, the base station may transmit information on one of various models or algorithms, from which a list of candidate beams for information on a specific serving beam is derived, and information on the number of candidate beams.

In the present disclosure, the method of deriving the candidate beams for the specific serving beam is not limited to the above-described method or information, and can be configured/set through various schemes based on the base station implementation.

Information transmitted and received between the UE and the base station is described in detail below.

When the UE newly enters any cell and establishes a connection to the cell, the UE may receive, from the base station, at least one of resource information on a reference signal, information on the algorithm/ML model for deriving the optimal candidate beams, and/or information on the number of optimal candidate beams.

At least one of the resource information on the reference signal, the information on the algorithm/ML model for deriving the optimal candidate beams, and/or the information on the number of optimal candidate beams may be broadcasted to cell system information (SIB-x) or transmitted from the base station as a unicast/multicast message depending on a request of the UE or a need of the base station.

Information transmitted and received between the UE and the base station is described in order below.

(Resource Information on Reference Signals of Configurable Beams within a Cell)

Resource information on reference signals (e.g., CSI-RS and/or SSB) of configurable beams within a cell may be transmitted and received. The beams are not limited by characteristics, and the reference signals may be reference signals for configurable narrow beams (M beams) within the cell.

The reference signals may consist of one or more sets within the cell, and may be configured cell-/sector-/UE group-/UE-specifically based on the base station implementation. For example, the reference signals may be configured and/or allocated cell-specifically or sector-specifically so that a plurality of UEs can use them together considering minimization in a system resource overhead and the size of beam information, and the resource information on the reference signals may be broadcasted to cell system information. This has an effect of reducing signaling overhead compared to the method of transmitting it as a unicast message as the number of UEs performing the beam management increases.

For example, the resource information on the reference signals may be a CSI-RS resource set. The CSI-RS resource set may include resources for one or more CSI-RSs. And/or, the CSI-RS resource set may refer to a bundle of reference signals that the UE uses to measure the beam intensity/quality. Each CSI-RS resource has a unique index within the set. The CSI-RS resources may refer to resources used (or resources pre-reserved for this) for CSI-RS transmission for quality measurement of a downlink beam of the UE.

The fact that the base station transmits the resource information on the reference signals may mean allocating only CSI-RS physical resources, rather than loading and transmitting actual signals using the CSI-RS resources. For example, the fact that the base station transmits the resource information on the reference signals may mean configuring/transmitting information on the physical resources of the reference signals.

This may mean that, when UE(s) connected to a subsequent cell performs a beam management procedure, the base station loads and transmits actual signals using only CSI-RS resources for optimal candidate beams selected based on a beam (e.g., serving beam) configured with a connection to the UE(s).

As another example, the resource information on the reference signals may be an SSB resource set.

The SSB resource set may include resources (information) for one or more SSBs and refer to resources periodically transmitted by the base station for beam connection of the UE that is not connected to the cell. The SSB resource set may mean a set including some of the SSBs when SSB sweeping information transmitted is reused as the SSB resource set or is transmitted UE-specifically.

### (Information on Model/Algorithm for Deriving Optimal Candidate Beams)

Information on an optimal candidate beam deriving model/algorithm (e.g., ML model) for a connected/selected beam (e.g., a serving beam) may be transmitted and received. The information may have a mapping relationship with resource information on reference signals (e.g., CSI-RS and/or SSB) of configurable beams within a specific cell. For example, if CSI-RS resource set #0 and SSB resource set #1 are defined, an optimal candidate beam deriving model/algorithm for each resource set may exist.

### (Information on the Number of Optimal Candidate Beams)

The number (N) of optimal candidate beams to be derived may be transmitted and received. The number (N) of optimal candidate beams may have a value less than the number (M) of reference signal resources (e.g., CSI-RS resources and/or SSB resources) within one reference signal set (e.g., CSI-RS resource set and/or SSB resource set)

Hereinafter, the present disclosure describes UE/BS operation performing a beam management procedure using the above-described information. For convenience of explanation, proposed methods of the present disclosure are described by being divided into a beam management method (or procedure) for a connected UE with a specific cell and a non-connected UE with the specific cell. The non-connected UE with the specific cell may be an idle UE or an inactive UE.

Bam Management Method for a Connected UE with a Specific Cell

A beam management method for a UE (i.e., a connected UE) configured with a connection to a specific cell is first described.

### UE Operation

First, a UE entering any cell may configure a connection to the cell through a cell connection process (e.g., RACH) and determine a serving beam of the UE, in step S10. For example, the UE may be connected to a serving transmit (Tx) beam.

This may be an initial access process or a handover process. The connected UE may be a UE that searches for at least one Tx beam in the connection configuration process and performs communication with the base station on a specific beam (e.g., serving beam).

The serving beam in an initial connection step may be a beam mapped to an SSB or a CSI-RS. If the serving beam is a beam mapped to the SSB and the base station wishes to configure a connection to a narrower beam than the beam mapped to the SSB within the cell, the base station may configure a connection of a narrower beam to the UE through a beam refinement operation (or procedure).

This may be performed as the base station transmits, to the UE, a message containing resource information for a UE-specific CSI-RS, in the same manner as the prior art. Alternatively, this may be performed using resource information for a cell-specific CSI-RS (or cell-specific CSI-RS resource configuration information) defined in the present disclosure.

Resource information on CSI-RS described in the present disclosure is resources allocated/reserved by the base station for CSI-RS transmission, and does not mean that all beams are swept (or transmitted) using the resources. That is, performing the beam refinement using the resource information for the cell-specific CSI-RS may mean that the base station transmits CSI-RSs with a quasi co-located (QCL) relationship with the SSB selected by the UE. And/or, the UE may receive, from the base station, information (or opposite information) for the SSB with a QCL relationship with the resource information for the CSI-RSs so as to know information for the transmitted CSI-RSs.

The UE may measure a signal of the CSI-RSs with the QCL relationship with the SSB (i.e., QCL-type D in the NR standard) to perform the beam refinement to a narrower beam than the serving beam mapped to the SSB, and may feed back a result of measurement to the base station. The base station may select one narrower beam based on this information and inform the UE of a refined serving beam.

And/or, the UE may receive a message containing or information including at least one of the resource information on the CSI-RS (or CSI-RS resource configuration), information on an optimal candidate beam deriving model/algorithm for the serving beam, information on the number (N) of candidate beams to be derived, and/or information on a channel measurement result reporting method (e.g., CSI report configuration), in step S20. A reception time of the corresponding information(s) may be before or after the connection to the serving beam is configured. As described above, if resource information on the cell-specific CSI-RS is pre-received in the beam refinement process and the corresponding information has been used, the pre-received information may be used.

And/or, the UE may derive N optimal candidate beams for the serving beam of the UE based on the received information (e.g., at least one of the resource information on the CSI-RS, the information on the optimal candidate beam deriving model/algorithm for the serving beam, the information on the number (N) of candidate beams to be derived, and/or the information on the channel measurement result reporting method), in step S30.

And/or, the UE may measure intensity/quality of reference signals (e.g., CSI-RSs/SSBs) corresponding to the selected N optimal candidate beams, in step S40. For example, the UE may check a resource location of the reference signals corresponding to the selected optimal candidate beams based on resource information on the received CSI-RSs and measure the signal intensity/quality of the CSI-RSs transmitted to the corresponding resources.

And/or, the UE may feed back a result value of the measured beam intensity/quality to the base station, in step S50. For example, the UE may report CSI. The UE may transmit a measurement result value (e.g., beam quality/RSRP) to the base station through a periodic, aperiodic, or semi-persistent method based on CSI report configuration configured by the base station.

And/or, the UE may be indicated a serving beam change (e.g., beam switching) from the base station, in step S60. The UE may repeat the steps S30 to S50 on the changed serving beam.

Next, a beam management method for a base station configured with a connection to a specific UE is described.

### BS Operation

First, when any UE newly enters a cell, a base station may configure a connection to the UE through a cell connection process (e.g., RACH procedure) and determine a serving beam of the UE, in step S11. For example, the UE may be connected to a serving Tx beam.

This may be an initial access process or a handover process. For example, the base station may receive information on at least one qualified Tx beam from the UE in the connection configuration process with the UE. The serving beam in an initial connection step may be a beam mapped to an SSB or a CSI-RS. If the serving beam is a beam mapped to the SSB and the base station wishes to configure a connection to a narrower beam than the beam mapped to the SSB within the cell, the base station may configure a connection of a narrower beam to the UE through a beam refinement procedure.

This may be performed as the base station transmits, to the UE, a message containing resource information for a UE-specific CSI-RS, in the same manner as the prior art. Alternatively, this may be performed using resource information for a cell-specific CSI-RS (or resource configuration information) defined in the present disclosure.

Resource information on CSI-RS described in the present disclosure is resources allocated/reserved by the base station for CSI-RS transmission, and does not mean that all beams for the reference signals are swept (or transmitted). That is, performing the beam refinement using the resource information for the cell-specific CSI-RS may mean that the base station transmits CSI-RSs with a QCL relationship with the SSB selected by the UE. The base station may include information (or opposite information) on the SSB with a QCL relationship with the CSI-RSs within the resource information for the reference signals, so that the base station informs the UE of information on the reference signals to be measured. The base station may receive, from the UE, a measurement result of the CSI-RSs with the QCL relationship with the SSB (i.e., QCL-type D in the NR) based on the information.

The base station may select one narrower beam based on the measurement result and inform the UE of a refined serving beam.

And/or, the base station may transmit a message containing or information including at least one of the resource information on the CSI-RS, information on an optimal candidate beam deriving model/algorithm for the serving beam, information on the number (N) of candidate beams to be derived, and/or information on a channel measurement result reporting method (e.g., CSI report configuration), in step S21. A transmission time of the corresponding information(s) may be before or after the connection to the serving beam is configured. As described above, if resource information on the cell-specific CSI-RS has been transmitted in advance in the beam refinement process, transmission of the resource information for the CSI-RS may be omitted.

And/or, the base station may derive N optimal candidate beams for the serving beam of the UE based on the transmitted information (e.g., at least one of the resource information on the CSI-RS, the information on the optimal candidate beam deriving model/algorithm for the serving beam, the information on the number (N) of candidate beams to be derived, and/or the information on the channel measurement result reporting method), in step S31.

And/or, the base station may transmit reference signals (CSI-RSs/SSBs) for the selected N optimal candidate beams (e.g., beam switching), in step S41.

And/or, the base station may receive, from the UE, a measurement result value for the optimal candidate beams, in step S51. For example, the base station may receive CSI. The measurement result value for the optimal candidate beams may be transmitted from the UE through a periodic, aperiodic, or semi-persistent method based on CSI report configuration configured to the UE by the base station.

And/or, the base station may determine to change the serving beam of the UE based on the beam measurement result value received from the UE and inform the UE of information on the changed beam, in step S61. The base station may repeat the steps S31 to S51 on the changed beam.

FIG. 13 illustrates an example of the beam management method described above.

Referring to FIG. 13, a base station (BS) may pre-transmit/pre-configure, to a user equipment (UE), configuration information including at least one of resource information on CSI-RS, information on an optimal candidate beam deriving model/algorithm for a serving beam, information on the number (N) of candidate beams to be derived, and/or information on a channel measurement result reporting method, before the serving beam is connected, in step S1301.

For example, the BS and the UE may share in advance resource information (e.g., CSI-RS/SSB resource set) on reference signals corresponding to M candidate beams that are configurable within a cell. For example, the BS and the UE which are configured with at least one serving beam may individually derive N optimal candidate beams for the serving beam without special signaling using an algorithm/ML model for the configurable M candidate beams within the cell pre-shared for beam management, and perform a beam management operation on the derived N optimal candidate beams (i.e., the BS may transmit the reference signals for the N optimal candidate beams, and the UE may transmit a measurement of the reference signals for the N optimal candidate beams and a feedback therefor and may be indicated a beam switching). Each time the serving beam changes, the optimal candidate beams of the UE may be derived without additional RRC signaling configuration.

And/or, each of the BS and the UE may derive the optimal candidate beams for the serving beam using the configuration information, in step S1302. The derived N candidate beams for the serving beam may be used for a beam management method, a beam failure recovery method, etc. when there is no connection to a specific cell to be described below, as well as a beam management method when there is a connection to a specific cell.

For example, in a beam failure recovery operation, the BS and the UE may map the N candidate beams derived in the beam management method to N CFRA resources, measure the N candidate beams, and perform the beam failure recovery operation using one CFRA resource based on a result of measurement. For example, if there is no change in the serving beam, the derived candidate beams for the serving beam may be used in other proposed methods of the present disclosure.

And/or, the UE may measure the (selected) optimal candidate beams and report a measurement value for the beams to the BS, in steps S1303 and S1304. Measuring the optimal candidate beams may mean receiving the reference signals and measuring them in reference signal resources corresponding to the selected optimal candidate beams.

And/or, the BS may indicate a change in the serving bean, in step S1305. In this instance, the BS may indicate a specific candidate beam based on measurement values for the optimal candidate beams. The steps S1302 to S1304 may be repeated multiple times.

Beam Management Method for a Non-Connected UE with a Specific Cell

Next, a beam management method for a non-connected UE (i.e., an idle UE/inactive UE) with a specific cell is described. For example, a UE operation applied to an SSB is described. It is obvious that the present disclosure can be applied to various reference signals such as CSI-RS as well as the SSB.

The non-connected UE with the specific cell may receive a paging message or perform short data transmission/reception through cell selection. For example, the short data transmission/reception may refer to a small data transmission (SDT) procedure.

Even in the non-connected UE with the specific cell, the UE may need to periodically perform a beam measurement so as to transmit and receive information within a cell. In the NR, the UE may select one qualified beam through SSB measurement and receive a paging message/SDT message mapped to a resource associated with it.

The UE that is not connected to the cell but can transmit and receive the message may require continuous beam measurement for the message transmission and reception or for the cell selection.

In the present disclosure, the UE may receive information on an algorithm/ML model, that derives optimal candidate SSBs for periodically transmitted SSBs, together with the SSB (or resource information on SSBs) or additionally. The UE receiving the information may derive the optimal candidate beams for the SSBs selected by the UE through the received information on the algorithm/ML model and select a next qualified beam through measurement of the derived candidate beams.

The UE (i.e., the idle UE/inactive UE) that is not connected with the specific cell (or in an idle mode) may not be required to transmit a feedback on a result of the beam measurement to the BS, but the UE can reduce power consumption of the UE by minimizing the number of beams to be measured.

FIG. 14 illustrates an example of SSB reception and measurement of an idle mode UE according to a prior art.

Referring to FIG. 14, a user equipment (UE) receives all SSBs from a base station (BS) before receiving a paging message each time, and measures all the SSBs. The UE selects one beam among the measured SSBs and receives a paging message connected to the selected beam. This method consumes a lot of power because it always measures all beams as illustrated in FIG. 14 (1401).

FIG. 15 illustrates an example of SSB reception and measurement of an idle mode UE described in the present disclosure. Referring to FIG. 15, a proposed method of the present disclosure first measures all SSBs, selects an SSB, and receives a paging message associated with the selected SSB. Therefore, power consumption of the proposed method may be the same as power consumption of the prior art (1501). In this instance, the UE may receive an ML model/algorithm together with the SSBs.

However, after the beginning, the UE derives only N optimal candidate beams among all the SSBs based on the first selected SSB (or serving beam) using the ML model and performs a measurement only on the optimal candidate beams to select a qualified beam. The UE may also receive a paging message associated with the selected beam. As described above, the proposed method of the present disclosure can minimize the power consumption by measuring only the optimal candidate beams not all the beams (1502). Information for deriving the optimal candidate beams, such as the ML model, may be pre-configured to the UE.

Alternatively, the UE may only measure the N optimal candidate beams derived based on the ML model from the beginning to perform the qualified beam. Alternatively, the UE may measure pre-derived N optimal candidate beams based on the above-described beam management method to perform the qualified beam.

As described above, the proposed method of the present disclosure can minimize the power consumption of the UE by performing the measurement only on the optimal candidate beams.

Next, an example of an application method to beam failure recovery (BFR) is described.

### Beam Failure Recovery Method

A beam failure recovery (BFR) method may be performed by configuring contention free random access (CFRA) resources for candidate beams and may operate in the same manner as the above-described beam management procedure for the non-connected UE with the specific cell.

In the present disclosure, a BFR method for a primary cell (Pcell) and/or a special cell (Spcell) is described below. It is obvious that proposed methods below can also be applied to a secondary cell (Scell). The Spcell may refer to a Pcell of a master cell group (MCG) or a primary secondary cell (PScell) of a secondary cell group (SCG).

If CFRA is used, a UE in the prior art shall pre-receive CFRA resource mapping information for up to 64 candidate beams from a base station. This means that new CFRA resource mapping information shall be received each time candidate beams change.

However, according to the proposed methods of the present disclosure, the base station may only need to assign N pieces of CFRA resource information to the UE. That is, unlike the prior art, according to the proposed methods of the present disclosure, the UE may be allocated, from the BS, only N pieces of CFRA resource information without mapping information with the beam. If there are two or more CSI-RS resource sets with a cell, N pieces of CFRA resource information for each CSI-RS resource set may be transmitted.

And/or, the BS and the UE may derive N optimal candidate beams based on a serving beam. And/or, the BS and the UE may sequentially map CFRA resources allocated for the UE in index order (ascending or descending order) of reference signals for the derived N candidate beams. And/or, the UE in which the BFR is triggered may select one qualified beam of the optimal candidate beams.

And/or, the UE may perform CFRA BFR using CFRA resources implicitly mapped to the selected beam.

In other words, according to the proposed methods of the present disclosure, the BS and the UE may receive only resource information for N CFRAs mapped to the N optimal candidate beams and perform the BFR operation.

FIG. 16 illustrates an example of a BFR procedure described in the present disclosure.

Referring to FIG. 16, a BS may transmit, to a UE, configuration information including at least one of resource information on reference signals, information on an algorithm/ML model for deriving optimal candidate beams, and/or N pieces of CFRA resource information, before a connection with the UE, in step S1601.

And/or, the UE and the BS derive N optimal candidate beams for a serving beam using the information on the algorithm/ML model for deriving the optimal candidate beams after a connection with the serving beam, and map N CFRA resources to the N optimal candidate beams, in step S1602. If the N optimal candidate beams for the serving beam have already been derived by the beam management method, etc., the N optimal candidate beams already derived may be used.

And/or, the UE measures the N optimal candidate beams and reports a result of measurement to the BS, in step S1603.

And/or, the BS indicates a connection to a new serving beam when serving beam switching is determined, and the UE and the BS change the serving beam, in step S1604.

And/or, the UE and the BS derive N optimal candidate beams for the changed serving beam and map the derived N optimal candidate beams to N CFRA resources, in step S1605. In other words, the N CFRA resources may be newly mapped to the N optimal candidate beams at the UE and the BS each time the serving beam of the UE changes.

And/or, the UE measures the N optimal candidate beams, in step S1606.

And/or, the UE performs the BFR using the CFRA resource mapped to a best beam of the optimal candidate beams measured in the step S1606 when the beam connection is lost, in step S1607. For example, the UE and/or the BS may perform the BFR based on CFRA resource #x corresponding to the best beam.

Next, a BFR MAC CE format described in the present disclosure is described.

### BFR MAC CE Format

The NR provides a BFR technique for Scell. This announces a candidate beam ID (candidate RS ID) for a cell, in which the BFR is generated, using MAC CE. This uses a format as described in the predefined standard (e.g., 3GPP TS38.321).

Hereinafter, after a BFR MAC CE format for the Scell of the NR is described, a BFR MAC CE format proposed in the present disclosure is described.

The BFR MAC CE format for the Scell of the NR is first described.

FIG. 17 illustrates BFR and Truncated BFR MAC CE in which the highest ServCellIndex of MAC entity's SCell configured with beam failure detection (BFD) is less than 8.

FIG. 18 illustrates BFR and Truncated BFR MAC CE in which the highest ServCellIndex of MAC entity's SCell configured with BFD is equal to or greater than 8.

Referring to FIGS. 17 and 18, MAC CE of BFR consists of BFR MAC CE or Truncated BFR MAC CE as follows.

The BFR MAC CE and the Truncated BFR MAC CE are identified by a MAC subheader with LCID/eLCID.

The BFR MAC CE and the Truncated BFR MAC CE have a variable sizes. They include a bitmap and in ascending order based on the ServCellIndex, beam failure recovery information, i.e., octets containing candidate beam availability indication (AC) for SCells indicated in the bitmap. For BFR MAC CE, a single octet bitmap is used when the highest ServCellIndex of this MAC entity's SCell for which beam failure is detected is less than 8, otherwise four octets are used. A MAC PDU shall contain at most one BFR MAC CE.

For Truncated BFR MAC CE, a single octet bitmap is used for the following cases, otherwise four octets are used.
the highest ServCellIndex of this MAC entity's SCell for which beam failure is detected is less than 8; or
beam failure/error is detected for SpCell, the SpCell is to be indicated in a Truncated BFR MAC CE, and UL-SCH resources available for transmission cannot accommodate the Truncated BFR MAC CE with the four octets bitmap plus its subheader as a result of LCP.

Fields in the BFR MAC CE are defined as follows.
SP: This field indicates beam failure detection for the SpCell of this MAC entity. The SP field is set to 1 to indicate that beam failure is detected for SpCell only when BFR MAC CE or Truncated BFR MAC CE is to be included into a MAC PDU as part of a random access procedure. Otherwise, this field is set to 0.
Ci (BFR MAC CE): This field indicates beam failure detection and the presence of an octet containing the AC field for the SCell with ServCellIndex i as specified in the predefined specifications (e.g., 3GPP TS 38.331). The Ci field set to 1 indicates that beam failure is detected and the octet containing the AC field is present for the SCell with ServCellIndex i. The Ci field set to 0 indicates that the beam failure is not detected and octet containing the AC field is not present for the SCell with ServCellIndex i. The octets containing the AC field are present in ascending order based on the ServCellIndex.
Ci (Truncated BFR MAC CE): This field indicates beam failure detection for the SCell with ServCellIndex i as specified in the predefined specifications (e.g., 3GPP TS 38.331). The Ci field set to 1 indicates that beam failure is detected and the octet containing the AC field for the SCell with ServCellIndex i may be present. The Ci field set to 0 indicates that the beam failure is not detected and the octet containing the AC field is not present for the SCell with ServCellIndex i. The octets containing the AC field (if present) are included in ascending order based on the ServCellIndex. The number of octets containing the AC field included is maximized, while not exceeding the available grant size.

For example, the number of the octets containing the AC field in the Truncated BFR MAC CE can be zero.
AC: This field indicates the presence of the Candidate RS ID field in this octet. If at least one of the SSBs with SS-RSRP above rsrp-ThresholdBFR among the SSBs in candidateBeamRSSCellList or at least one of the CSI-RSs with CSI-RSRP above rsrp-ThresholdBFR among the CSI-RSs in candidateBeamRSSCellList is available, the AC field is set to 1. Otherwise, this field is set to 0. If the AC field is set to 1, the Candidate RS ID field is present. If the AC field is set to 0, R bits are present instead.
Candidate RS ID: This field is set to the index of an SSB with SS-RSRP above rsrp-ThresholdBFR among the SSBs in candidateBeamRSSCellList or to the index of a CSI-RS with CSI-RSRP above rsrp-ThresholdBFR among the CSI-RSs in candidateBeamRSSCellList. The length of this field is 6 bits. The index of the SSB or the CSI-RS is an index of an entry in candidateBeamRSSCellList corresponding to the SSB or the CSI-RS. Index 0 corresponds to candidateBeamRSCellList, and index 1 corresponds to a second entry in a list, etc. The length of this field is 6 bits.

Next, a BFR MAC CE format proposed in the present disclosure is described.

The proposed method of the present disclosure may use an N-bit long bitmap for the optimal candidate beam, instead of using a candidate RS ID of the BFR MAC CE to reduce overhead of the MAC CE.

FIG. 19 illustrates an example of BFR MAC CE described in the present disclosure.

FIG. 19 illustrates an example in which N is 6. Referring to FIG. 19, the meaning of the Ci and AC fields may be used in the same meaning as the conventional format. However, instead of the prior art notifying ID for candidate beams, only information on a qualified beam of candidate beams may be notified using an N-bit long bitmap. That is, N optimal candidate beams derived by the algorithm/ML model may be mapped to B0 to B5 in descending or ascending order of beam index. In this instance, the UE may set the bit for beams with beam intensity exceeding a specific threshold among the measured optimal candidate beams to 1 to thereby inform the base station of the qualified beam for a cell in which the BFR is generated.

And/or, in the proposed method of the present disclosure, if most of the derived N beams through learning are assumed to be the qualified beams, it may be defined to notify only information on the best beam among the N beams using the bitmap. And/or, if there are more qualified beams than need to be reported, only information on a certain number of best beams may be notified through the bitmap.

The BFR MAC CE of the corresponding bitmap format may be defined to map to the same N-bit long bitmap for SP and/or cells of C1 to C24 even for the Truncated BFR MAC CE. The BFR MAC CE format described in the present disclosure may be used in the beam failure recovery method described above.

The BFR MAC CE described in the present disclosure can be applied to Spcell or Pcell as well as Scell. For example, in the Spcell, if beam failure is detected and CFRA resources are present, the BFR may be performed using the CFRA resources. If there is no CFRA resource, the BFR may be performed through the RACH procedure by including the above-proposed BFR MAC CE in Msg3 or MsgA.

Next, an example of a method of reporting feedback information proposed in the present disclosure is described.

### Feedback Information Reporting Method

In the present disclosure, reporting of feedback information including measurement result values for optimal candidate beams may be required from a UE. For example, the feedback information may be CSI.

Although transmission of the feedback information may follow the prior art, the present disclosure proposes an additional method of reducing a feedback information overhead. In the method of deriving N optimal candidate beams using the algorithm/ML model, a value of N is much smaller than 64 in the prior technique and may be larger than 1.

Since the candidate beams in the NR can be set to up to 64, the NR transmits up to 4 measurement result values to reduce an overhead therefor. Therefore, in the NR, since RSRP transmission for four beams with the highest RSRP among 64 beams is required, the beams are transmitted on “SSBR1(s)+L1-RSRP(s)” or “CRI(s)+L1-RSRP(s).” Further, in the NR, a differential RSRP value based on highest RSRP is reported to reduce the RSRP overhead.

In the NR, a bitwidth for each of a CSI-RS resource indicator (CRI), a synchronization signal/physical broadcast channel resource block indicator (SSBR1), RSRP, and differential RSRP is shown in Table 2 below.

TABLE 2

| Field | Bitwidth |
|---|---|
| CRI | ┌log₂(Kₛ^{CSI-RS})┐ |
| SSBRI | ┌log₂(Kₛ^{SSB})┐ |
| RSRP | 7 |
| Differential RSRP | 4 |

In Table 2, Kₛ^{CSI-RS} is the number of CSI-RS resources in the resource set, and Kₛ^{SSB} is the number of SS/PBCH blocks configured in the resource set for reporting ‘ssb-Index-RSRP’.

That is, when the number of beams is set to up to 64, the number of bits for CRI and SSBR1 is 6 bits, and 24 bits of information are transmitted for a total of 4 beams. If information of RSRP (7 bits)+differential RSRP (4 bits)*3=19 bits is transmitted, transmission of up to 43 bits of information is required. However, according to the proposed methods of the present disclosure, since information on the optimal candidate beams between the UE and the BS is always matched between transmission (Tx) and reception (Rx), it is possible to transmit RSRP information, in which SSBR1 and/or CRI are omitted, using this information. This may be the case when the value of N (e.g., the number of optimal candidate beams) is sufficiently small. For example, because the UE and the BS already share the N optimal candidate beams with each other, only RSSP information can be transmitted and received without SSBR1 and/or CRI.

In addition, the present disclosure proposes the following methods to reduce the feedback overhead.

(Feedback proposed method 1) The UE may sequentially transmit only RSRP values of measurement result values for the N optimal candidate beams derived using the algorithm/ML model in the order of N optimal candidate beam indexes.

If CSI-RS resources #4, 7, 8, 10 are selected as the N optimal candidate beams, L1-RSRP (i.e., 7 bits*4=28 bits) may be transmitted in ascending order from the lowest CSI-RS resource index. The method may be useful when the value of N is less than 6. If N=6, transmission of 7 bits*6=42 bits of information may be required. If N=4, only transmission of 28 bits of information is required, and there is an effect of reducing 15-bit overhead compared to the prior art.

And/or, differential RSRP may be transmitted based on the RSRP value for the lowest index. However, in this case, because additional indication of negative or positive number may be required, differential RSRP may require 5-bit length information. If N=4, only transmission of 7+(5*3)=22 bits of information is required, and there is an effect of reducing 21-bit overhead compared to the prior art.

(Feedback proposed method 2) The UE may transmit only information on x beams (e.g., 4 beams) with the highest RSRP using information (e.g., N-bit bitmap) on an N-bit bitmap. The method may be useful when the value of N is less than 15. For example, if N=10, each bit may be mapped in descending order of index through a 10-bit long bitmap, and after only four indexes with the highest RSRP are set to 1, RSRP values may be transmitted in index order. In this case, the total length of information may be 10+(7*4)=38 bits.

And/or, the present disclosure proposes a method of flexibly applying the N value used as the number of candidate beams to be selected. That is, the BS may transmit, to the UE, resource information on reference signals (e.g. beam resource information), an optimal candidate beam deriving algorithm/ML model, and an RSRP threshold (e.g., CSI-RS/SSB RSRP threshold) together with the N value. The UE receiving the information may derive the N optimal candidate beams and measure a beam quality/intensity for them. In this instance, if none of the N optimal candidate beams exceeds a specific RSRP threshold received from the base station (or if an average value of the measurement results (RSRP) for the N beams is equal to or less than a specific threshold), the UE may increase the number (N) of optimal candidate beams for a next measurement by 1 (or a) while transmitting the measurement result values for the corresponding beams to the base station.

The base station receiving the measurement result values for the corresponding beams may determine that there is no beam exceeding the RSRP threshold (or the average value of the measurement results (RSRP) for the N beams is equal to or less than the specific threshold), increase the value of N by 1 (or a) and then derive the increased number (N+1 or N+α) of optimal candidate beams, and transmit (N+1) (or N+α) reference signals corresponding to the beams. The value of N may also define a maximum value, and various methods for increase or decrease can be applied using the measured/reported result values.

In the proposed methods of the present disclosure, different beams may be used for the control channel and the data channel, or the beam for the control channel may be considered the serving beam.

In the proposed methods of the present disclosure, when one or more beams are connected, the beam management may be performed on each of the one or more connected beams. In the proposed methods of the present disclosure, the serving beam may refer to a Tx beam of the base station.

The proposed methods of the present disclosure may be applied when a repetition parameter for beam management of the conventional NR is OFF.

According to the present disclosure, based on information learned about beams within a cell, the BS and the UE can derive only optimal candidate beams for a specific serving beam without signaling. Through this, the present disclosure enables resource configuration of reference signals for beams within a wider coverage using a larger CSI-RS/SSB resource set.

According to the present disclosure, by enabling measurement of beams with a larger coverage without radio resource control (RRC) reconfiguration, there is an effect of reducing beam tracking latency that may occur due to reconfiguration of reference signal resources for the beams.

According to the present disclosure, even if reference signal information (or resource information for reference signals) for beams belonging to a larger coverage is received via one RRC configuration, there is also an effect of reducing power consumption of the UE by only requiring measurement for the minimum number of beams.

According to the present disclosure, from a system performance perspective, because the base station reduces unnecessary reference signal transmission and beam transmission is possible using only resources for the derived N reference signals (e.g., CSI-RS), there is also an effect of improving system performance.

According to the present disclosure, if the value of N is sufficiently small, an effect of reducing the overhead of beam information feedback can be achieved through various methods.

FIG. 20 is a flow chart illustrating an operation method of a UE described in the present disclosure.

Referring to FIG. 20, a UE (1000/2000 of FIGS. 22 to 31) may receive, from a base station (BS), configuration information including i) resource information on a plurality of reference signals and ii) candidate beam determination algorithm information, in step S2001. For example, the candidate beam determination algorithm information may be information on an algorithm/ML model for deriving optimal candidate beams described above. For example, the configuration information may further include information on the number of optimal candidate beams described above.

For example, an operation of the UE to receive the configuration information in the step S2001 may be implemented by a device of FIGS. 22 to 31 to be described below. For example, referring to FIG. 23, one or more processors 1020 may control one or more memories 1040 and/or one or more RF units 1060 so as to transmit the configuration information, and the one or more RF units 1060 may receive the configuration information.

And/or, the UE (1000/2000 of FIGS. 22 to 31) may determine N candidate beams for at least one serving beam based on the candidate beam determination algorithm information, in step S2002. The N candidate beams may correspond to N reference signals of the plurality of reference signals. For example, when the N candidate beams for the serving beam are pre-determined, the pre-determined N candidate beams may be used without the step S2002. For example, if multiple serving beams are present, N candidate beams may be derived for each serving beam.

For example, an operation of the UE to determine the N candidate beams in the step S2002 may be implemented by the device of FIGS. 22 to 31 to be described below. For example, referring to FIG. 23, one or more processors 1020 may determine the N candidate beams.

And/or, the UE (1000/2000 of FIGS. 22 to 31) may receive, from the BS, the N reference signals of the plurality of reference signals based on the resource information on the plurality of reference signals, in step S2003. The UE measures only the N reference signals corresponding to the N candidate beams among the plurality of reference signals not measuring all the plurality of reference signals configured.

For example, an operation of the UE to receive the N reference signals of the plurality of reference signals in the step S2003 may be implemented by the device of FIGS. 22 to 31 to be described below. For example, referring to FIG. 23, one or more processors 1020 may control one or more memories 1040 and/or one or more RF units 1060 so as to receive the N reference signals, and the one or more RF units 1060 may receive the N reference signals.

And/or, the UE (1000/2000 of FIGS. 22 to 31) may transmit, to the BS, measurement information including at least one measurement value among the N reference signals, in step S2004. The number of measurement values included in the measurement information may be pre-configured by the BS. For example, the measurement information may be feedback information described above.

For example, the measurement information may be transmitted based on a method of reporting the feedback information.

For example, an operation of the UE to transmit the measurement information in the step S2004 may be implemented by the device of FIGS. 22 to 31 to be described below. For example, referring to FIG. 23, one or more processors 1020 may control one or more memories 1040 and/or one or more RF units 1060 so as to transmit the measurement information, and the one or more RF units 1060 may transmit the measurement information.

And/or, based on the at least one serving beam being changed, new N candidate beams may be determined using the candidate beam determination algorithm information. For example, the N candidate beams may be changed based on change in the serving beam. For example, if two or more serving cells or serving beams are configured, the proposed methods of the present disclosure may be applied to each serving cell or each serving beam. And/or, if two or more serving cells or serving beams are configured, the candidate beam determination algorithm may be configured for each serving cell or each serving beam.

And/or, based on there being no reference signal whose the measurement value exceeds a threshold among the measured N reference signals, the number of candidate beams for measurement may be increased by +1. The UE may measure the increased (N+1) candidate beams, and if there is a candidate beam exceeding the threshold, the UE may report this. If there is no candidate beam exceeding the threshold, the UE may increase the number of candidate beams to N+2. For example, a maximum number of candidate beams that can be increased may be preset by the base station.

And/or, the configuration information may further include at least one of information on N contention free random access (CFRA) resources and/or information on the number of candidate beams.

And/or, based on the pre-configured method, the UE may map the N CFRA resources to the N reference signals, determine one beam corresponding to one reference signal of the N reference signals based on the resource information on the plurality of reference signals, and perform a beam failure recovery operation using the CFRA resource corresponding to the one beam. For example, the beam failure recovery operation may refer to an operation for the UE to transmit a preamble using the CFRA resources. Alternatively, the beam failure recovery operation may refer to an operation for the UE to notify a qualified beam or a best beam through BFR MAC CE information described in the present disclosure.

For example, the N reference signals or the N candidate beams corresponding to the N reference signals may be pre-derived reference signals or candidate beams.

And/or, based on a beam failure of the at least one serving beam being detected, the UE may measure the N reference signals using the resource information on the plurality of reference signals, and transmit beam failure recovery (BFR) medium access control (MAC)-control element (CE) information to the BS. The BFR MAC-CE information may include a bitmap representing a reference signal, whose a measurement value exceeds a threshold among the N reference signals, for at least one serving cell. For example, one serving cell may include a control channel and a data channel. The control channel and the data channel may be configured with the same beam (or serving beam) or different beams (or serving beams).

Since the operation of the UE described with reference to FIG. 20 is the same as the operation of the UE described with reference to FIGS. 1 to 19, a detailed operation thereof is omitted.

The signaling and the operation described above may be implemented by a device (e.g., FIGS. 22 to 31) to be described below. For example, the signaling and the operation described above may be processed by one or more processors 1010 and 2020 of FIGS. 22 to 31, and the signaling and the operation described above may be stored in a memory (e.g., 1040/2040) in the form of commands/programs (e.g., instructions, executable codes) for running at least one processor (e.g., 1010/2020) of FIGS. 22 to 31.

For example, in a device comprising one or more memories and one or more processors operatively connected to the one or more memories, the one or more processors may be configured to allow a UE to receive, from a BS, configuration information including i) resource information on a plurality of reference signals and ii) candidate beam determination algorithm information, determine N candidate beams for at least one serving beam based on the candidate beam determination algorithm information, the N candidate beams corresponding to N reference signals of the plurality of reference signals, receive, from the BS, the N reference signals of the plurality of reference signals based on the resource information on the plurality of reference signals, and transmit, to the BS, measurement information including at least one measurement value among the N reference signals.

As another example, in a non-transitory computer readable medium (CRM) storing one or more instructions, the one or more instructions executable by one or more processors may allow a UE to receive, from a BS, configuration information including i) resource information on a plurality of reference signals and ii) candidate beam determination algorithm information, determine N candidate beams for at least one serving beam based on the candidate beam determination algorithm information, the N candidate beams corresponding to N reference signals of the plurality of reference signals, receive, from the BS, the N reference signals of the plurality of reference signals based on the resource information on the plurality of reference signals, and transmit, to the BS, measurement information including at least one measurement value among the N reference signals.

FIG. 21 is a flow chart illustrating an operation method of a base station (BS) described in the present disclosure.

Referring to FIG. 21, a BS (1000/2000 of FIGS. 22 to 31) may transmit, to a UE, configuration information including i) resource information on a plurality of reference signals and ii) candidate beam determination algorithm information, in step S2101. For example, the candidate beam determination algorithm information may be information on an algorithm/ML model for deriving optimal candidate beams described above. For example, the configuration information may further include information on the number of optimal candidate beams described above.

For example, an operation of the BS to transmit the configuration information in the step S2101 may be implemented by a device of FIGS. 22 to 31 to be described below. For example, referring to FIG. 23, one or more processors 1020 may control one or more memories 1040 and/or one or more RF units 1060 so as to transmit the configuration information, and the one or more RF units 1060 may transmit the configuration information.

And/or, the BS (1000/2000 of FIGS. 22 to 31) may determine N candidate beams for at least one serving beam based on the candidate beam determination algorithm information, in step S2102. The N candidate beams may correspond to N reference signals of the plurality of reference signals. For example, when the N candidate beams for the serving beam are pre-determined, the pre-determined N candidate beams may be used without the step S2102. For example, if multiple serving beams are present, N candidate beams may be derived for each serving beam.

For example, an operation of the BS to determine the N candidate beams in the step S2102 may be implemented by the device of FIGS. 22 to 31 to be described below. For example, referring to FIG. 23, one or more processors 1020 may determine the N candidate beams.

And/or, the BS (1000/2000 of FIGS. 22 to 31) may transmit, to the UE, the N reference signals of the plurality of reference signals based on the resource information on the plurality of reference signals, in step S2103. The UE measures only the N reference signals corresponding to the N candidate beams among the plurality of reference signals not measuring all the plurality of reference signals configured.

For example, an operation of the BS to transmit the N reference signals of the plurality of reference signals in the step S2103 may be implemented by the device of FIGS. 22 to 31 to be described below. For example, referring to FIG. 23, one or more processors 1020 may control one or more memories 1040 and/or one or more RF units 1060 so as to transmit the N reference signals, and the one or more RF units 1060 may transmit the N reference signals.

And/or, the BS (1000/2000 of FIGS. 22 to 31) may receive, from the UE, measurement information including at least one measurement value among the N reference signals, in step S2104. The number of measurement values included in the measurement information may be pre-configured by the BS. For example, the measurement information may be feedback information described above.

For example, the measurement information may be transmitted based on a method of reporting the feedback information.

For example, an operation of the BS to receive the measurement information in the step S2104 may be implemented by the device of FIGS. 22 to 31 to be described below. For example, referring to FIG. 23, one or more processors 1020 may control one or more memories 1040 and/or one or more RF units 1060 so as to receive the measurement information, and the one or more RF units 1060 may receive the measurement information.

And/or, based on the at least one serving beam being changed, new N candidate beams may be determined using the candidate beam determination algorithm information. For example, the N candidate beams may be changed based on change in the serving beam. For example, if two or more serving cells or serving beams are configured, the proposed methods of the present disclosure may be applied to each serving cell or each serving beam. And/or, if two or more serving cells or serving beams are configured, the candidate beam determination algorithm may be configured for each serving cell or each serving beam.

And/or, based on there being no reference signal whose the measurement value exceeds a threshold among the measured N reference signals, the number of candidate beams for measurement may be increased by +1. The UE may measure the increased (N+1) candidate beams, and if there is a candidate beam exceeding the threshold, the UE may report this. If there is no candidate beam exceeding the threshold, the UE may increase the number of candidate beams to N+2. For example, a maximum number of candidate beams that can be increased may be preset by the base station.

And/or, the configuration information may further include at least one of information on N contention free random access (CFRA) resources and/or information on the number of candidate beams.

And/or, based on the pre-configured method, the UE may map the N CFRA resources to the N reference signals and perform a beam failure recovery operation using the CFRA resource corresponding to one reference signal of the N reference signals. For example, the beam failure recovery operation may refer to an operation for the UE to transmit a preamble using the CFRA resources. Alternatively, the beam failure recovery operation may refer to an operation for the UE to notify a qualified beam or a best beam through BFR MAC CE information described in the present disclosure.

For example, the N reference signals or the N candidate beams corresponding to the N reference signals may be pre-derived reference signals or candidate beams.

And/or, based on a beam failure of the at least one serving beam being detected, the N reference signals may be measured using the resource information on the plurality of reference signals, and beam failure recovery (BFR) medium access control (MAC)-control element (CE) information is received from the UE. The BFR MAC-CE information may include a bitmap representing a reference signal, whose a measurement value exceeds a threshold among the N reference signals, for at least one serving cell. For example, one serving cell may include a control channel and a data channel. The control channel and the data channel may be configured with the same beam (or serving beam) or different beams (or serving beams).

Since the operation of the BS described with reference to FIG. 21 is the same as the operation of the BS described with reference to FIGS. 1 to 20, a detailed operation thereof is omitted.

The signaling and the operation described above may be implemented by a device (e.g., FIGS. 22 to 31) to be described below. For example, the signaling and the operation described above may be processed by one or more processors 1010 and 2020 of FIGS. 22 to 31, and the signaling and the operation described above may be stored in a memory (e.g., 1040/2040) in the form of commands/programs (e.g., instructions, executable codes) for running at least one processor (e.g., 1010/2020) of FIGS. 22 to 31.

For example, in a device comprising one or more memories and one or more processors operatively connected to the one or more memories, the one or more processors may be configured to allow a BS to transmit, to a UE, configuration information including i) resource information on a plurality of reference signals and ii) candidate beam determination algorithm information, determine N candidate beams for at least one serving beam based on the candidate beam determination algorithm information, the N candidate beams corresponding to N reference signals of the plurality of reference signals, transmit, to the UE, the N reference signals of the plurality of reference signals based on the resource information on the plurality of reference signals, and receive, from the UE, measurement information including at least one measurement value among the N reference signals.

As another example, in a non-transitory computer readable medium (CRM) storing one or more instructions, the one or more instructions executable by one or more processors may allow a BS to transmit, to a UE, configuration information including i) resource information on a plurality of reference signals and ii) candidate beam determination algorithm information, determine N candidate beams for at least one serving beam based on the candidate beam determination algorithm information, the N candidate beams corresponding to N reference signals of the plurality of reference signals, transmit, to the UE, the N reference signals of the plurality of reference signals based on the resource information on the plurality of reference signals, and receive, from the UE, measurement information including at least one measurement value among the N reference signals.

Example of Communication System to which the Present Disclosure is Applied

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

FIG. 22 shows a communication system 10 based on an embodiment of the present disclosure.

Referring to FIG. 22, a communication system 10 to which various embodiments of the present disclosure are applied includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 1000a, vehicles 1000b-1 and 1000b-2, an eXtended Reality (XR) device 1000c, a hand-held device 1000d, a home appliance 1000e, an Internet of Things (IoT) device 1000f, and an Artificial Intelligence (AI) device/server 4000. For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 2000a may operate as a BS/network node with respect to other wireless devices.

The wireless devices 1000a to 1000f may be connected to the network 3000 via the BSs 2000. An AI technology may be applied to the wireless devices 1000a to 1000f and the wireless devices 1000a to 1000f may be connected to the AI server 4000 via the network 3000. The network 3000 may be configured using a 3G network, a 4G (e.g., LTE) network, or a 5G (e.g., NR) network. Although the wireless devices 1000a to 1000f may communicate with each other through the BSs 2000/network 3000, the wireless devices 1000a to 1000f may perform direct communication (e.g., sidelink communication) with each other without passing through the BSs/network. For example, the vehicles 1000b-1 and 1000b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 1000a to 1000f.

Wireless communication/connections 1500a, 1500b, or 1500c may be established between the wireless devices 1000a to 1000f/BS 2000, or BS 2000/BS 2000. Herein, the wireless communication/connections may be established through various RATs (e.g., 5G NR) such as uplink/downlink communication 1500a, sidelink communication 1500b (or, D2D communication), or inter BS communication (e.g. relay, Integrated Access Backhaul (IAB)). The wireless devices and the BSs/the wireless devices may transmit/receive radio signals to/from each other through the wireless communication/connections 1500a and 1500b. For example, the wireless communication/connections 1500a and 1500b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Example of Wireless Device to which the Present Disclosure is Applied

FIG. 23 shows wireless devices based on an embodiment of the present disclosure.

Referring to FIG. 23, a first wireless device 1000 and a second wireless device 2000 may transmit radio signals through a variety of RATs (e.g., LTE and NR). Herein, {the first wireless device 1000 and the second wireless device 2000) may correspond to (the wireless device 1000x and the BS 2000} and/or (the wireless device 1000x and the wireless device 1000x) of FIG. 25.

The first wireless device 1000 may include one or more processors 1020 and one or more memories 1040 and additionally further include one or more transceivers 1060 and/or one or more antennas 1080. The processor(s) 1020 may control the memory(s) 1040 and/or the transceiver(s) 1060 and may be configured to implement the descriptions, functions, procedures, proposals, methods, and/or operational flowcharts disclosed in this document. For example, the processor(s) 1020 may process information within the memory(s) 1040 to generate first information/signals and then transmit radio signals including the first information/signals through the transceiver(s) 1060. The processor(s) 1020 may receive radio signals including second information/signals through the transceiver 1060 and then store information obtained by processing the second information/signals in the memory(s) 1040. The memory(s) 1040 may be connected to the processor(s) 1020 and may store a variety of information related to operations of the processor(s) 1020. For example, the memory(s) 1040 may store software code including commands for performing a part or the entirety of processes controlled by the processor(s) 1020 or for performing the descriptions, functions, procedures, proposals, methods, and/or operational flowcharts disclosed in this document. Herein, the processor(s) 1020 and the memory(s) 1040 may be a part of a communication modem/circuit/chip designed to implement RAT (e.g., LTE or NR). The transceiver(s) 1060 may be connected to the processor(s) 1020 and transmit and/or receive radio signals through one or more antennas 1080. Each of the transceiver(s) 1060 may include a transmitter and/or a receiver. The transceiver(s) 1060 may be interchangeably used with Radio Frequency (RF) unit(s). In the present disclosure, the wireless device may represent a communication modem/circuit/chip.

The second wireless device 2000 may include one or more processors 2020 and one or more memories 2040 and additionally further include one or more transceivers 2060 and/or one or more antennas 2080. The processor(s) 2020 may control the memory(s) 2040 and/or the transceiver(s) 2060 and may be configured to implement the descriptions, functions, procedures, proposals, methods, and/or operational flowcharts disclosed in this document. For example, the processor(s) 2020 may process information within the memory(s) 2040 to generate third information/signals and then transmit radio signals including the third information/signals through the transceiver(s) 2060. The processor(s) 2020 may receive radio signals including fourth information/signals through the transceiver(s) 1060 and then store information obtained by processing the fourth information/signals in the memory(s) 2040. The memory(s) 2040 may be connected to the processor(s) 2020 and may store a variety of information related to operations of the processor(s) 2020. For example, the memory(s) 2040 may store software code including commands for performing a part or the entirety of processes controlled by the processor(s) 2020 or for performing the descriptions, functions, procedures, proposals, methods, and/or operational flowcharts disclosed in this document. Herein, the processor(s) 2020 and the memory(s) 2040 may be a part of a communication modem/circuit/chip designed to implement RAT (e.g., LTE or NR). The transceiver(s) 206 may be connected to the processor(s) 2020 and transmit and/or receive radio signals through one or more antennas 2080. Each of the transceiver(s) 2060 may include a transmitter and/or a receiver. The transceiver(s) 2060 may be interchangeably used with RF unit(s). In the present disclosure, the wireless device may represent a communication modem/circuit/chip.

Hereinafter, hardware elements of the wireless devices 1000 and 2000 will be described more specifically. One or more protocol layers may be implemented by, without being limited to, one or more processors 1020 and 2020. For example, the one or more processors 1020 and 2020 may implement one or more layers (e.g., functional layers such as PHY, MAC, RLC, PDCP, RRC, and SDAP). The one or more processors 1020 and 2020 may generate one or more Protocol Data Units (PDUs) and/or one or more Service Data Unit (SDUs) based on the descriptions, functions, procedures, proposals, methods, and/or operational flowcharts disclosed in this document. The one or more processors 1020 and 2020 may generate messages, control information, data, or information based on the descriptions, functions, procedures, proposals, methods, and/or operational flowcharts disclosed in this document. The one or more processors 1020 and 2020 may generate signals (e.g., baseband signals) including PDUs, SDUs, messages, control information, data, or information based on the descriptions, functions, procedures, proposals, methods, and/or operational flowcharts disclosed in this document and provide the generated signals to the one or more transceivers 106 and 206. The one or more processors 1020 and 2020 may receive the signals (e.g., baseband signals) from the one or more transceivers 1060 and 2060 and acquire the PDUs, SDUs, messages, control information, data, or information based on the descriptions, functions, procedures, proposals, methods, and/or operational flowcharts disclosed in this document.

The one or more processors 1020 and 2020 may be referred to as controllers, microcontrollers, microprocessors, or microcomputers. The one or more processors 1020 and 2020 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 1020 and 2020. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 1020 and 2020 or stored in the one or more memories 1040 and 2040 so as to be driven by the one or more processors 1020 and 2020. The descriptions, functions, procedures, proposals, methods, and/or operational flowcharts disclosed in this document may be implemented using firmware or software in the form of code, commands, and/or a set of commands.

The one or more memories 1040 and 2040 may be connected to the one or more processors 1020 and 2020 and store various types of data, signals, messages, information, programs, code, instructions, and/or commands. The one or more memories 1040 and 2040 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 1040 and 2040 may be located at the interior and/or exterior of the one or more processors 1020 and 2020. The one or more memories 1040 and 2040 may be connected to the one or more processors 1020 and 2020 through various technologies such as wired or wireless connection.

The one or more transceivers 1060 and 2060 may transmit user data, control information, and/or radio signals/channels, mentioned in the methods and/or operational flowcharts of this document, to one or more other devices. The one or more transceivers 1060 and 2060 may receive user data, control information, and/or radio signals/channels, mentioned in the descriptions, functions, procedures, proposals, methods, and/or operational flowcharts disclosed in this document, from one or more other devices. For example, the one or more transceivers 1060 and 2060 may be connected to the one or more processors 1020 and 2020 and transmit and receive radio signals. For example, the one or more processors 1020 and 2020 may perform control so that the one or more transceivers 1060 and 2060 may transmit user data, control information, or radio signals to one or more other devices. The one or more processors 1020 and 2020 may perform control so that the one or more transceivers 1060 and 2060 may receive user data, control information, or radio signals from one or more other devices. The one or more transceivers 1060 and 2060 may be connected to the one or more antennas 1080 and 2080 and the one or more transceivers 1060 and 2060 may be configured to transmit and receive user data, control information, and/or radio signals/channels, mentioned in the descriptions, functions, procedures, proposals, methods, and/or operational flowcharts disclosed in this document, through the one or more antennas 1080 and 2080. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 1020 and 2020. The one or more transceivers 1060 and 2060 may convert the user data, control information, radio signals/channels, etc. processed using the one or more processors 1020 and 2020 from the base band signals into the RF band signals. To this end, the one or more transceivers 1060 and 2060 may include (analog) oscillators and/or filters.

Example of Signal Processing Circuit to which the Present Disclosure is Applied

FIG. 24 shows a signal process circuit for a transmission signal based on an embodiment of the present disclosure.

Referring to FIG. 24, a signal processing circuit 10000 may include scramblers 10100, modulators 10200, a layer mapper 10300, a precoder 10400, resource mappers 10500, and signal generators 10600. An operation/function of FIG. 27 may be performed, without being limited to, the processors 1020 and 2020 and/or the transceivers 1060 and 2060 of FIG. 23. Hardware elements of FIG. 24 may be implemented by the processors 102 and 202 and/or the transceivers 1060 and 2060 of FIG. 23. For example, blocks 10100 to 10600 may be implemented by the processors 1020 and 2020 of FIG. 23. Alternatively, the blocks 10100 to 10500 may be implemented by the processors 1020 and 2020 of FIG. 23 and the block 10600 may be implemented by the transceivers 1060 and 2060 of FIG. 23.

Codewords may be converted into radio signals via the signal processing circuit 10000 of FIG. 24. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 10100. Scramble sequences used for scrambling may be generated based on an initialization value, and the initialization value may include ID information of a wireless device. The scrambled bit sequences may be modulated to modulation symbol sequences by the modulators 10200. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 10300. Modulation symbols of each transport layer may be mapped (precoded) to corresponding antenna port(s) by the precoder 10400. Outputs z of the precoder 10400 may be obtained by multiplying outputs y of the layer mapper 10300 by an N*M precoding matrix W. Herein, N is the number of antenna ports and M is the number of transport layers. The precoder 10400 may perform precoding after performing transform precoding (e.g., DFT) for complex modulation symbols. Alternatively, the precoder 10400 may perform precoding without performing transform precoding.

The resource mappers 10500 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 10600 may generate radio signals from the mapped modulation symbols and the generated radio signals may be transmitted to other devices through each antenna. For this purpose, the signal generators 10600 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 10100 to 10600 of FIG. 24. For example, the wireless devices (e.g., 1000 and 2000 of FIG. 23 may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

Application Example of Wireless Device to which the Present Disclosure is Applied

FIG. 25 shows another example of a wireless device based on an embodiment of the present disclosure.

The wireless device may be implemented in various forms based on a use-case/service.

Referring to FIG. 25, wireless devices 1000 and 2000 may correspond to the wireless devices 1000 and 2000 of FIG. 23 and may be configured by various elements, components, units/portions, and/or modules. For example, each of the wireless devices 1000 and 2000 may include a communication unit 1100, a control unit 1200, a memory unit 130, and additional components 1400. The communication unit may include a communication circuit 1120 and transceiver(s) 1140. For example, the communication circuit 1120 may include the one or more processors 1020 and 2020 and/or the one or more memories 1040 and 2040 of FIG. 23. For example, the transceiver(s) 1140 may include the one or more transceivers 106 and 206 and/or the one or more antennas 1080 and 2080 of FIG. 23. The control unit 1200 is electrically connected to the communication unit 1100, the memory 1300, and the additional components 1400 and controls overall operation of the wireless devices. For example, the control unit 1200 may control an electric/mechanical operation of the wireless device based on programs/code/commands/information stored in the memory unit 1300. The control unit 1200 may transmit the information stored in the memory unit 1300 to the exterior (e.g., other communication devices) via the communication unit 1100 through a wireless/wired interface or store, in the memory unit 1300, information received through the wireless/wired interface from the exterior (e.g., other communication devices) via the communication unit 1100.

The additional components 1400 may be variously configured based on types of wireless devices. For example, the additional components 1400 may include at least one of a power unit/battery, input/output (I/O) unit, a driving unit, and a computing unit. The wireless device may be implemented in the form of, without being limited to, the robot (1000a of FIG. 22), the vehicles (1000b-1 and 1000b-2 of FIG. 22), the XR device (1000c of FIG. 22), the hand-held device (1000d of FIG. 22), the home appliance (1000e of FIG. 22), the IoT device (1000f of FIG. 22), a digital broadcast terminal, a hologram device, a public safety device, an MTC device, a medicine device, a fintech device (or a finance device), a security device, a climate/environment device, the AI server/device (4000 of FIG. 22), the BSs (2000 of FIG. 22), a network node, etc. The wireless device may be used in a mobile or fixed place based on a use-example/service.

In FIG. 25, the entirety of the various elements, components, units/portions, and/or modules in the wireless devices 1000 and 2000 may be connected to each other through a wired interface or at least a part thereof may be wirelessly connected through the communication unit 1100. For example, in each of the wireless devices 1000 and 2000, the control unit 1200 and the communication unit 1100 may be connected by wire and the control unit 1200 and first units (e.g., 1300 and 1400) may be wirelessly connected through the communication unit 1100. Each element, component, unit/portion, and/or module within the wireless devices 1000 and 2000 may further include one or more elements. For example, the control unit 1200 may be configured by a set of one or more processors. As an example, the control unit 1200 may be configured by a set of a communication control processor, an application processor, an Electronic Control Unit (ECU), a graphical processing unit, and a memory control processor. As another example, the memory 1300 may be configured by a Random Access Memory (RAM), a Dynamic RAM (DRAM), a Read Only Memory (ROM)), a flash memory, a volatile memory, a non-volatile memory, and/or a combination thereof.

FIG. 26 shows a hand-held device based on an embodiment of the present disclosure.

The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 26, a hand-held device 1000 may include an antenna unit 1080, a communication unit 1100, a control unit 1200, a memory unit 1300, a power supply unit 1400a, an interface unit 1400b, and an I/O unit 1400c. The antenna unit 108 may be configured as a part of the communication unit 1100. Blocks 1100 to 1300/1400a to 1400c correspond to the blocks 1100 to 1300/1400 of FIG. 28, respectively.

The communication unit 1100 may transmit and receive signals (e.g., data and control signals) to and from other wireless devices or BSs. The control unit 1200 may perform various operations by controlling constituent elements of the hand-held device 1000. The control unit 1200 may include an Application Processor (AP). The memory unit 1300 may store data/parameters/programs/code/commands needed to drive the hand-held device 1000. The memory unit 1300 may store input/output data/information. The power supply unit 1400a may supply power to the hand-held device 1000 and include a wired/wireless charging circuit, a battery, etc. The interface unit 1400b may support connection of the hand-held device 1000 to other external devices. The interface unit 1400b may include various ports (e.g., an audio I/O port and a video I/O port) for connection with external devices. The I/O unit 1400c may input or output video information/signals, audio information/signals, data, and/or information input by a user. The I/O unit 1400c may include a camera, a microphone, a user input unit, a display unit 1400d, a speaker, and/or a haptic module.

As an example, in the case of data communication, the I/O unit 1400c may acquire information/signals (e.g., touch, text, voice, images, or video) input by a user and the acquired information/signals may be stored in the memory unit 1300. The communication unit 1100 may convert the information/signals stored in the memory into radio signals and transmit the converted radio signals to other wireless devices directly or to a BS. The communication unit 1100 may receive radio signals from other wireless devices or the BS and then restore the received radio signals into original information/signals. The restored information/signals may be stored in the memory unit 1300 and may be output as various types (e.g., text, voice, images, video, or haptic) through the I/O unit 1400c.

FIG. 27 shows a vehicle or an autonomous vehicle based on an embodiment of the present disclosure. The vehicle or autonomous vehicle may be implemented by a mobile robot, a car, a train, a manned/unmanned Aerial Vehicle (AV), a ship, etc.

Referring to FIG. 27, a vehicle or autonomous vehicle 1000 may include an antenna unit 1080, a communication unit 1100, a control unit 1200, a driving unit 1400a, a power supply unit 1400b, a sensor unit 1400c, and an autonomous driving unit 1400d. The antenna unit 1080 may be configured as a part of the communication unit 1100. The blocks 1100/1300/1400a to 1400d correspond to the blocks 1100/1300/1400 of FIG. 25, respectively.

The communication unit 1100 may transmit and receive signals (e.g., data and control signals) to and from external devices such as other vehicles, BSs (e.g., gNBs and road side units), and servers. The control unit 1200 may perform various operations by controlling elements of the vehicle or the autonomous vehicle 1000. The control unit 1200 may include an Electronic Control Unit (ECU). The driving unit 1400a may cause the vehicle or the autonomous vehicle 1000 to drive on a road. The driving unit 1400a may include an engine, a motor, a powertrain, a wheel, a brake, a steering device, etc. The power supply unit 1400b may supply power to the vehicle or the autonomous vehicle 1000 and include a wired/wireless charging circuit, a battery, etc. The sensor unit 1400c may acquire a vehicle state, ambient environment information, user information, etc. The sensor unit 1400c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 1400d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 1100 may receive map data, traffic information data, etc. from an external server. The autonomous driving unit 1400d may generate an autonomous driving path and a driving plan from the obtained data. The control unit 1200 may control the driving unit 1400a such that the vehicle or the autonomous vehicle 1000 may move along the autonomous driving path based on the driving plan (e.g., speed/direction control). In the middle of autonomous driving, the communication unit 1100 may aperiodically/periodically acquire recent traffic information data from the external server and acquire surrounding traffic information data from neighboring vehicles. In the middle of autonomous driving, the sensor unit 1400c may obtain a vehicle state and/or surrounding environment information. The autonomous driving unit 1400d may update the autonomous driving path and the driving plan based on the newly obtained data/information. The communication unit 1100 may transfer information about a vehicle position, the autonomous driving path, and/or the driving plan to the external server. The extremal server may predict traffic information data using AI technology, etc., based on the information collected from vehicles or autonomous vehicles and provide the predicted traffic information data to the vehicles or the autonomous vehicles.

FIG. 28 shows a vehicle based on an embodiment of the present disclosure. The vehicle may be implemented as a transport means, an aerial vehicle, a ship, etc.

Referring to FIG. 28, a vehicle 1000 may include a communication unit 1100, a control unit 1200, a memory unit 1300, an I/O unit 1400a, and a positioning unit 1400b. Herein, the blocks 1100 to 1300/1400a and 1400b correspond to blocks 1100 to 1300/1400 of FIG. 25.

The communication unit 1100 may transmit and receive signals (e.g., data and control signals) to and from external devices such as other vehicles or BSs. The control unit 1200 may perform various operations by controlling constituent elements of the vehicle 1000. The memory unit 1300 may store data/parameters/programs/code/commands for supporting various functions of the vehicle 1000. The I/O unit 140a may output an AR/VR object based on information within the memory unit 1300. The I/O unit 140a may include an HUD. The positioning unit 1400b may acquire information about the position of the vehicle 1000. The position information may include information about an absolute position of the vehicle 1000, information about the position of the vehicle 1000 within a traveling lane, acceleration information, and information about the position of the vehicle 1000 from a neighboring vehicle. The positioning unit 1400b may include a GPS and various sensors.

As an example, the communication unit 1100 of the vehicle 1000 may receive map information and traffic information from an external server and store the received information in the memory unit 1300. The positioning unit 1400b may obtain the vehicle position information through the GPS and various sensors and store the obtained information in the memory unit 1300. The control unit 1200 may generate a virtual object based on the map information, traffic information, and vehicle position information and the I/O unit 1400a may display the generated virtual object in a window in the vehicle (14100 and 14200). The control unit 1200 may determine whether the vehicle 1000 normally drives within a traveling lane, based on the vehicle position information. If the vehicle 1000 abnormally exits from the traveling lane, the control unit 1200 may display a warning on the window in the vehicle through the I/O unit 1400a. In addition, the control unit 1200 may broadcast a warning message regarding driving abnormity to neighboring vehicles through the communication unit 1100. Based on situation, the control unit 1200 may transmit the vehicle position information and the information about driving/vehicle abnormality to related organizations.

FIG. 29 shows an XR device based on an embodiment of the present disclosure. The XR device may be implemented by an HMD, an HUD mounted in a vehicle, a television, a smartphone, a computer, a wearable device, a home appliance, a digital signage, a vehicle, a robot, etc.

Referring to FIG. 29, an XR device 1000a may include a communication unit 1100, a control unit 1200, a memory unit 1300, an I/O unit 1400a, a sensor unit 1400b, and a power supply unit 1400c. Herein, the blocks 1100 to 1300/1400a to 1400c correspond to the blocks 1100 to 1300/1400 of FIG. 25, respectively.

The communication unit 1100 may transmit and receive signals (e.g., media data and control signals) to and from external devices such as other wireless devices, hand-held devices, or media servers. The media data may include video, images, and sound. The control unit 1200 may perform various operations by controlling constituent elements of the XR device 1000a. For example, the control unit 1200 may be configured to control and/or perform procedures such as video/image acquisition, (video/image) encoding, and metadata generation and processing. The memory unit 1300 may store data/parameters/programs/code/commands needed to drive the XR device 1000a/generate XR object. The I/O unit 1400a may obtain control information and data from the exterior and output the generated XR object. The I/O unit 1400a may include a camera, a microphone, a user input unit, a display unit, a speaker, and/or a haptic module. The sensor unit 1400b may obtain an XR device state, surrounding environment information, user information, etc. The sensor unit 1400b may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone and/or a radar. The power supply unit 1400c may supply power to the XR device 1000a and include a wired/wireless charging circuit, a battery, etc.

For example, the memory unit 1300 of the XR device 1000a may include information (e.g., data) needed to generate the XR object (e.g., an AR/VR/MR object). The I/O unit 1400a may receive a command for manipulating the XR device 1000a from a user and the control unit 1200 may drive the XR device 1000a based on a driving command of a user. For example, when a user desires to watch a film or news through the XR device 1000a, the control unit 1200 transmits content request information to another device (e.g., a hand-held device 1000b) or a media server through the communication unit 1300. The communication unit 1300 may download/stream content such as films or news from another device (e.g., the hand-held device 1000b) or the media server to the memory unit 1300. The control unit 1200 may control and/or perform procedures such as video/image acquisition, (video/image) encoding, and metadata generation/processing with respect to the content and generate/output the XR object based on information about a surrounding space or a real object obtained through the I/O unit 1400a/sensor unit 1400b.

The XR device 1000a may be wirelessly connected to the hand-held device 1000b through the communication unit 1100 and the operation of the XR device 1000a may be controlled by the hand-held device 1000b. For example, the hand-held device 1000b may operate as a controller of the XR device 1000a. To this end, the XR device 1000a may obtain information about a 3D position of the hand-held device 1000b and generate and output an XR object corresponding to the hand-held device 1000b.

FIG. 30 shows a robot based on an embodiment of the present disclosure. The robot may be categorized into an industrial robot, a medical robot, a household robot, a military robot, etc., based on a used purpose or field.

Referring to FIG. 30, a robot 1000 may include a communication unit 1 10, a control unit 1200, a memory unit 1300, an I/O unit 1400a, a sensor unit 1400b, and a driving unit 1400c. Herein, the blocks 1100 to 1300/1400a to 1400c correspond to the blocks 1100 to 1300/1400 of FIG. 25, respectively.

The communication unit 1100 may transmit and receive signals (e.g., driving information and control signals) to and from external devices such as other wireless devices, other robots, or control servers. The control unit 1200 may perform various operations by controlling constituent elements of the robot 1000. The memory unit 1300 may store data/parameters/programs/code/commands for supporting various functions of the robot 1000. The I/O unit 140a may obtain information from the exterior of the robot 1000 and output information to the exterior of the robot 1000. The I/O unit 140a may include a camera, a microphone, a user input unit, a display unit, a speaker, and/or a haptic module. The sensor unit 1400b may obtain internal information of the robot 1000, surrounding environment information, user information, etc. The sensor unit 1400b may include a proximity sensor, an illumination sensor, an acceleration sensor, a magnetic sensor, a gyro sensor, an inertial sensor, an IR sensor, a fingerprint recognition sensor, an ultrasonic sensor, a light sensor, a microphone, a radar, etc. The driving unit 1400c may perform various physical operations such as movement of robot joints. In addition, the driving unit 1400c may cause the robot 1000 to travel on the road or to fly. The driving unit 1400c may include an actuator, a motor, a wheel, a brake, a propeller, etc.

FIG. 31 shows an AI device based on an embodiment of the present disclosure. The AI device may be implemented by a fixed device or a mobile device, such as a TV, a projector, a smartphone, a PC, a notebook, a digital broadcast terminal, a tablet PC, a wearable device, a Set Top Box (STB), a radio, a washing machine, a refrigerator, a digital signage, a robot, a vehicle, etc.

Referring to FIG. 31, an AI device 1000 may include a communication unit 1100, a control unit 1200, a memory unit 1300, an I/O unit 1400a/1400b, a learning processor unit 1400c, and a sensor unit 1400d. The blocks 1100 to 1300/1400a to 1400d correspond to blocks 1100 to 1300/1400 of FIG. 25, respectively.

The communication unit 1100 may transmit and receive wired/radio signals (e.g., sensor information, user input, learning models, or control signals) to and from external devices such as other AI devices (e.g., 1000x, 2000, or 4000 of FIG. 22) or an AI server (e.g., 4000 of FIG. 22) using wired/wireless communication technology. To this end, the communication unit 1100 may transmit information within the memory unit 1300 to an external device and transmit a signal received from the external device to the memory unit 1300.

The control unit 1200 may determine at least one feasible operation of the AI device 1000, based on information which is determined or generated using a data analysis algorithm or a machine learning algorithm. The control unit 1200 may perform an operation determined by controlling constituent elements of the AI device 1000. For example, the control unit 1200 may request, search, receive, or use data of the learning processor unit 1400c or the memory unit 1300 and control the constituent elements of the AI device 1000 to perform a predicted operation or an operation determined to be preferred among at least one feasible operation. The control unit 1200 may collect history information including the operation contents of the AI device 1000 and operation feedback by a user and store the collected information in the memory unit 130X) or the learning processor unit 1400c or transmit the collected information to an external device such as an AI server (4000 of FIG. 22). The collected history information may be used to update a learning model.

The memory unit 1300 may store data for supporting various functions of the AI device 100. For example, the memory unit 1300 may store data obtained from the input unit 1400a, data obtained from the communication unit 1100, output data of the learning processor unit 1400c, and data obtained from the sensor unit 1400. The memory unit 1300 may store control information and/or software code needed to operate/drive the control unit 1200.

The input unit 1400a may acquire various types of data from the exterior of the AI device 1000. For example, the input unit 1400a may acquire learning data for model learning, and input data to which the learning model is to be applied. The input unit 1400a may include a camera, a microphone, and/or a user input unit. The output unit 1400b may generate output related to a visual, auditory, or tactile sense. The output unit 1400b may include a display unit, a speaker, and/or a haptic module. The sensing unit 1400 may obtain at least one of internal information of the AI device 1000, surrounding environment information of the AI device 1000, and user information, using various sensors. The sensor unit 1400 may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone, and/or a radar.

The learning processor unit 1400c may learn a model consisting of artificial neural networks, using learning data. The learning processor unit 1400c may perform AI processing together with the learning processor unit of the AI server (4000 of FIG. 22). The learning processor unit 1400c may process information received from an external device through the communication unit 1100 and/or information stored in the memory unit 1300. In addition, an output value of the learning processor unit 1400c may be transmitted to the external device through the communication unit 1100 and may be stored in the memory unit 1300.

The embodiments described above are implemented by combinations of components and features of the present disclosure in predetermined forms. Each component or feature should be considered selectively unless specified separately. Each component or feature can be carried out without being combined with another component or feature. Moreover, some components and/or features are combined with each other and can implement embodiments of the present disclosure. The order of operations described in embodiments of the present disclosure can be changed. Some components or features of one embodiment may be included in another embodiment, or may be replaced by corresponding components or features of another embodiment. It is apparent that some claims referring to specific claims may be combined with another claims referring to the claims other than the specific claims to constitute the embodiment or add new claims by means of amendment after the application is filed.

Embodiments of the present disclosure can be implemented by various means, for example, hardware, firmware, software, or combinations thereof. When embodiments are implemented by hardware, one embodiment of the present disclosure can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

When embodiments are implemented by firmware or software, one embodiment of the present disclosure can be implemented by modules, procedures, functions, etc. performing functions or operations described above. Software code can be stored in a memory and can be driven by a processor. The memory is provided inside or outside the processor and can exchange data with the processor by various well-known means.

It is apparent to those skilled in the art that the present disclosure can be implemented in other specific forms without departing from necessary features of the present disclosure. Accordingly, the present disclosure described in detail above should not be interpreted as limiting in all aspects and should be considered as illustrative. The scope of the present disclosure should be determined by rational interpretation of the appended claims, and all modifications within an equivalent scope of the present disclosure are included in the scope of the present disclosure.

### INDUSTRIAL APPLICABILITY

Although a method of performing beam management in a wireless communication system according to the present disclosure has been described focusing on examples applying to 3GPP LTE/LTE-A system, 5G system (New RAT system), and 6G/Beyond 6G system, the present disclosure can be applied to various wireless communication systems other than these systems.

1. A method of performing, by a user equipment (UE), a beam management in a wireless communication system, the method comprising:
receiving, from a base station (BS), configuration information including i) resource information on a plurality of reference signals and ii) candidate beam determination algorithm information;
determining N candidate beams for at least one serving beam based on the candidate beam determination algorithm information, the N candidate beams being related to N reference signals of the plurality of reference signals;
receiving, from the BS, the N reference signals of the plurality of reference signals based on the resource information on the plurality of reference signals; and
transmitting, to the BS, measurement information including at least one measurement value among the N reference signals.

2. The method of claim 1, wherein, based on the at least one serving beam being changed, new N candidate beams are determined based on the candidate beam determination algorithm information.

3. The method of claim 1, wherein, based on there being no reference signal whose a measurement value exceeds a threshold among the measured N reference signals, a number of candidate beams for measurement is increased by +1.

4. The method of claim 1, wherein the configuration information further includes at least one of information on N contention free random access (CFRA) resources and/or information on a number of candidate beams.

5. The method of claim 4, further comprising:
based on a pre-configured method, mapping the N CFRA resources to the N reference signals;
determining one beam related to one reference signal of the N reference signals based on the resource information on the plurality of reference signals; and
performing a beam failure recovery operation based on a CFRA resource related to the one beam.

6. The method of claim 1, further comprising:
based on a beam failure of the at least one serving beam being detected, measuring the N reference signals based on the resource information on the plurality of reference signals; and
transmitting, to the BS, beam failure recovery (BFR) medium access control (MAC)-control element (CE) information,
wherein the BFR MAC-CE information includes a bitmap representing a reference signal, whose a measurement value exceeds a threshold among the N reference signals, for at least one serving cell.

7. A user equipment (UE) configured to perform a beam management in a wireless communication system, the UE comprising:
at least one transceiver;
at least one processor operatively connected to the at least one transceiver; and
at least one memory operatively connected to the at least one processor and configured to store instruction that allow the at least one processor to perform operations,
wherein the operations comprise:
receiving, from a base station (BS), configuration information including i) resource information on a plurality of reference signals and ii) candidate beam determination algorithm information;
determining N candidate beams for at least one serving beam based on the candidate beam determination algorithm information, the N candidate beams being related to N reference signals of the plurality of reference signals;
receiving, from the BS, the N reference signals of the plurality of reference signals based on the resource information on the plurality of reference signals; and
transmitting, to the BS, measurement information including at least one measurement value among the N reference signals.

8. A method of performing, by a base station (BS), a beam management in a wireless communication system, the method comprising:
transmitting, to a user equipment (UE), configuration information including i) resource information on a plurality of reference signals and ii) candidate beam determination algorithm information;
determining N candidate beams for at least one serving beam based on the candidate beam determination algorithm information, the N candidate beams being related to N reference signals of the plurality of reference signals;
transmitting, to the UE, the N reference signals of the plurality of reference signals based on the resource information on the plurality of reference signals; and
receiving, from the UE, measurement information including at least one measurement value among the N reference signals.

9. The method of claim 8, wherein, based on the at least one serving beam being changed, new N candidate beams are determined based on the candidate beam determination algorithm information.

10. The method of claim 8, wherein, based on there being no reference signal whose a measurement value exceeds a threshold among the measured N reference signals, a number of candidate beams for measurement is increased by +1.

11. The method of claim 8, wherein the configuration information further includes at least one of information on N contention free random access (CFRA) resources and/or information on a number of candidate beams.

12. The method of claim 11, further comprising:
based on a pre-configured method, mapping the N CFRA resources to the N reference signals; and
performing a beam failure recovery operation based on a CFRA resource related to one reference signal of the N reference signals.

13. The method of claim 8, wherein, based on a beam failure of the at least one serving beam being detected, the N reference signals are measured based on the resource information on the plurality of reference signals,
wherein the method further comprises receiving, from the UE, beam failure recovery (BFR) medium access control (MAC)-control element (CE) information, and
wherein the BFR MAC-CE information includes a bitmap representing a reference signal, whose a measurement value exceeds a threshold among the N reference signals, for at least one serving cell.

14-16. (canceled)
